(19) United States
(12) Patent Application Publication
(10) Pub. No.: US 2025/0299286 A1
(43) Pub. Date: Sep. 25, 2025

(54) GRAPHICS PROCESSING SYSTEMS

(71) Applicant: Arm Limited, Cambridge (GB)

(72) Inventors: Frank Klaeboe Langtind, Melhus (NO); Andreas Danner Nilsen, Trondheim (NO); Andreas Due Engh-Halstvedt, Trondheim (NO)

(73) Assignee: Arm Limited, Cambridge (GB)

(21) Appl. No.: 18/613,876

(22) Filed: Mar. 22, 2024

(51) Int. Cl. G06T 1/20; G06T 15/00

(52) U.S. Cl. CPC G06T 1/20; G06T 15/005

(57) ABSTRACT

A graphics processor comprising processing circuits to execute a plurality of pipeline stages for a graphics processing pipeline. To update some or all pipeline configuration information for the graphics processing pipeline, state update commands are issued to the graphics processing pipeline that cause respective local copies of relevant portions of the pipeline configuration information maintained by each pipeline stage to be updated, as required, and a copy of the full pipeline configuration information to be updated once the state update command has passed through the pipeline in full.

### BACKGROUND

The technology described herein relates to graphics processing, and graphics processors, and in particular to the operation and configuration of a graphics processor to execute a (graphics) processing pipeline.

Graphics processing is normally carried out by first splitting a scene (e.g. a 3-D model) to be displayed into a number of similar basic components or “primitives”, which primitives are then subjected to the desired graphics processing operations. The graphics “primitives” are usually in the form of simple polygons, such as triangles.

Each primitive is usually defined by and represented as a set of vertices, where each vertex typically has associated with it a set of “attributes”, i.e. a set of data values for the vertex. These attributes will typically include position data and other, non-position data (varyings), e.g. defining colour, light, normal, texture coordinates, etc, for the vertex in question.

For a given output, e.g. frame to be displayed, to be generated by the graphics processing system, there will typically be a set of vertices defined for the output in question. The primitives to be processed for the output will then be indicated as comprising given vertices in the set of vertices for the graphics processing output being generated. Typically, the overall output, e.g. frame to be generated, will be divided into smaller units of processing, referred to as “draw calls”. Each draw call will have a respective set of vertices defined for it and a set of primitives that use those vertices.

Once primitives and their vertices have been generated and defined, they can be processed by the graphics processing system, in order to generate the desired graphics processing output (render target), such as a frame for display. This basically involves rendering the primitives to generate the graphics processing output.

The rendering process uses the vertex attributes associated with the vertices of the primitives that are being processed. To facilitate this operation, the vertices defined for the given graphics processing output (e.g. draw call) are usually subjected to an initial so-called “vertex shading” operation, before the primitives are rendered.

The vertex shading operation typically produces (transformed) vertex positions and one or more outputs explicitly written by the vertex shader. (Attributes output from the vertex shader other than position are usually referred to as “varyings”.)

A graphics processing pipeline will typically therefore include one or more vertex shading stages (vertex shader(s)) that execute vertex shading operations, e.g. using the initial vertex attribute values defined for the vertices (and otherwise), so as to generate a desired set of output vertex attributes (i.e. appropriately “shaded” attributes) for use in subsequent pipeline stages of the graphics processing pipeline.

Once the vertex attributes have been shaded, the “shaded” attributes are then used when processing the vertices (and the primitives to which they relate) in the remainder of the graphics processing pipeline.

For example, the “vertex shaded” vertex positions and varyings may be used when rendering the primitives to provide the render output, for example when performing rasterisation and/or fragment shading operations. In the case of a tile-based graphics processing pipeline (where the two-dimensional render output (target) is rendered as a plurality of smaller area sub-regions, usually referred to as “tiles”), the vertex shaded (transformed) positions may be used to sort the primitives relative to the rendering tiles and/or to derive data structures for allowing the primitives to be sorted relative to the rendering tiles.

A vertex shading operation in a graphics processing pipeline will, accordingly, process one or more and typically a plurality of vertices (which can correspondingly be considered to be respective “work items” for the shading operation), to produce a respective “vertex shaded” attribute or attributes for each vertex (work item) that is processed (which attribute or attributes can correspondingly be considered to be respective data elements for the vertex (work item) in question).

Graphics processing pipelines can also include various other (shading) stages that process respective work items and generate a respective data element or elements for each of the work items that they process.

For example, in more advanced geometry processing flows, e.g., where tessellation is enabled, the vertex shading stages described above may be followed by one or more tessellation stages, which tessellation stages typically include a tessellation control shader (TCS) stage (e.g. that determines an amount of tessellation to perform), a tessellation stage that performs the desired tessellation operations (e.g. by executing a tessellation shader and/or using a (fixed-function) tessellation hardware circuit), and a tessellation evaluation shader (TES) (that applies interpolation or other post-processing operations on the tessellated output). More advanced graphics processing flows may also include other stages that perform vertex post-processing such as, but not limited to, a transform feedback stage that captures primitives generated by the vertex processing.

As another example, rather than performing vertex processing (shading) in the manner described above, a graphics processing pipeline may be configured to implement so-called “task” and “mesh” shading stages (shaders). Compared to traditional vertex shading operations, wherein a vertex shader may simply load in a certain number of vertices and then process (i.e. shade) them, a mesh shading stage (mesh shader) is operable to create its own output vertices and primitives.

For instance, a task shading stage (task shader) (also sometimes referred to as an “amplification” shader) can be executed to determine how many child mesh shader workgroups should be launched in a subsequent mesh shading stage (mesh shader). Each mesh shader workgroup can then produce a respective set of output vertices and primitives (i.e. a “meshlet”) with all mesh shader workgroups together creating the full output mesh (and so mesh shaders may perform “compute” shader-like processing in which mesh shader workgroups cooperatively generate meshes).

A task shader may also optionally output a payload that is passed to any of its child mesh shader workgroups.

The use of such “task” and “mesh” shaders can at least in some cases thus provide greater flexibility for the application programmer, e.g. compared to graphics processing pipelines that implement more traditional vertex shading operations, as the inputs to and outputs from the task” and “mesh” shaders can be customised.

Thus, a graphics processor may execute a graphics processing pipeline to support a desired graphics processing flow, and the graphics processor (hardware) may accordingly be configured to support the particular graphics processing pipeline that is desired to be executed by the graphics processor. In this regard, it would be possible to execute any desired graphics processing pipeline in software, e.g. using general purpose compute shader operations. However, this is not normally efficient, and so some level of hardware support is often provided for the graphics processing pipeline, with the pipeline stages typically being specialised to perform certain processing operations for executing a particular graphics processing pipeline.

The Applicants believe, however, that there remains scope for improved arrangements in this regard when a graphics processor is to execute a (graphics) processing pipeline.

### BRIEF DESCRIPTION OF THE DRAWINGS

Embodiments of the technology described herein will now be described by way of example only and with reference to the accompanying drawings, in which:

FIG. 1 shows an exemplary data processing system in which the technology described herein may be implemented;

FIG. 2 shows an exemplary graphics processing pipeline;

FIG. 3 shows schematically a graphics processor that may be operated in accordance with the technology described herein;

FIG. 4 shows schematically another graphics processor that may be operated in accordance with the technology described herein;

FIG. 5 shows an example of a geometry packet pipeline that may be executed according to an embodiment;

FIG. 6 shows in more detail a generic shader stage circuit within the graphics processing pipeline according to an embodiment;

FIG. 7 is a flow chart illustrating the “frontend” processing operations within a generic shader stage circuit according to an embodiment;

FIG. 8 is a flow chart illustrating the management of a packet queue within a generic shader stage circuit according to an embodiment;

FIG. 9 is a flow chart illustrating the “backend” processing operations within a generic shader stage circuit according to an embodiment;

FIG. 10 shows schematically the layout of a geometry buffer according to an embodiment;

FIG. 11, FIG. 12 and FIG. 13 show an example of the operation of a geometry packet pipeline according to an embodiment; and

FIG. 14 shows further details of a graphics processor that may be operated in accordance with the technology described herein;

FIG. 15 shows a snapshot of a graphics processing pipeline when processing a series of state update commands according to an embodiment;

FIG. 16 is a flow chart illustrating the processing of a state update command within a shader stage according to an embodiment;

FIG. 17 is a flowchart illustrating the processing of a state update command within a post-pipeline stage according to an embodiment;

FIG. 18 is a flowchart illustrating the processing of a state update command within a state manager stage according to an embodiment;

FIG. 19 is a flow chart illustrating draining of a pipeline in response to an update to memory allocation between draw calls according to an embodiment; and

FIG. 20 shows an example of a descriptor checksum cache entry according to an embodiment.

### DETAILED DESCRIPTION

A first embodiment of the technology described herein comprises a method of operating a graphics processor, the graphics processor comprising:
one or more processing circuits configured to execute a plurality of pipeline stages for a processing pipeline, wherein the operation of the one or more processing circuits to execute the processing pipeline is controlled based on a set of pipeline configuration information,
wherein a copy of a full set of pipeline configuration information including respective portions of pipeline configuration information relating to individual pipeline stages defining the processing pipeline is stored in association with the processing pipeline as a whole, and
wherein an individual pipeline stage of the plurality of pipeline stages is operable and configured to separately maintain a local copy of a respective portion of the pipeline configuration information relating to that pipeline stage,
the method comprising:
(when it is desired) to update some or all of the set of pipeline configuration information:
issuing a corresponding state update command to update the set of pipeline configuration information into the processing pipeline; and
once the state update command has passed though the processing pipeline, updating the copy of the full set of pipeline configuration information that is stored in association with the processing pipeline as a whole;
the method further comprising:
when the state update command is to update a respective portion of pipeline configuration information relating to a particular pipeline stage, the particular pipeline stage when processing the state update command updating its respective local copy of that respective portion of the pipeline configuration information accordingly.

A second embodiment of the technology described herein comprises a graphics processor comprising:
one or more processing circuits configured to execute a plurality of pipeline stages for a processing pipeline, wherein the operation of the one or more processing circuits to execute the processing pipeline is controlled based on a set of pipeline configuration information; and
a “post pipeline” stage that is operable and configured to store, for the processing pipeline as a whole, a copy of a full set of pipeline configuration information including respective portions of pipeline configuration information relating to individual pipeline stages defining the processing pipeline,
wherein an individual pipeline stage of the plurality of pipeline stages is operable and configured to separately maintain a local copy of a respective portion of the pipeline configuration information relating to that pipeline stage,
and wherein the graphics processor operable and configured to:
in response to a state update command to update some or all of the set of pipeline configuration information being issued into the processing pipeline:
once the state update command has passed through the processing pipeline, update the copy of the full set of pipeline configuration information that is stored in the “post pipeline” stage for the processing pipeline as a whole; and
when the state update command is to update a respective portion of pipeline configuration information relating to a particular pipeline stage, process the state update command by that particular pipeline stage to update the local copy of that respective portion of the pipeline configuration information that is maintained by that particular pipeline stage.

The technology described herein relates generally to graphics processors and graphics processor operation, in particular when executing a processing pipeline.

In particular, a graphics processor according to the technology described herein comprises one or more processing circuits (which will also be referred to herein as “shader stage circuits”) that can be used and configured to execute a plurality of pipeline stages for a processing pipeline. The processing pipeline is thus associated with a set of pipeline configuration information that defines and controls the operation of the pipeline stages that are to be executed as part of the processing pipeline. In other words, the operation of the one or more processing (shader stage) circuits to execute the processing pipeline is controlled based on such pipeline configuration information.

A suitable set of pipeline configuration information to be used for one or more instances of processing pipeline execution may thus be determined, e.g. in software, in advance, during an initial pipeline configuration. The set of pipeline configuration information can then be suitably transferred into the graphics processor and used to control the operation of the one or more shader stage circuits to execute the processing pipeline in the desired manner.

For example, the initial pipeline configuration may be performed by a main (e.g. host) processor of a data processing system that the graphics processor is a part of, and a descriptor of the pipeline configuration information may thus be transferred into the graphics processor as part of a command set that is issued from the main (host) processor to the graphics processor to cause the graphics processor to perform processing work.

In order to re-configure the processing pipeline, e.g. to re-configure the processing pipeline in some way between instances of processing pipeline execution (e.g. between draw calls) to perform different processing/generate a different output, a further pipeline configuration may thus be performed, and a new/updated set of pipeline configuration information issued to the graphics processor accordingly.

This can work well in many cases. However, the Applicants recognise that it may be desirable to be able to update such pipeline configuration information in a more dynamic fashion, and in particular to be able to do this locally to the graphics processor, i.e. under control of the graphics processor (hardware) (e.g. rather than receiving a new (static) set of pipeline configuration information in ‘full’ from the main (e.g. host) processor).

As will be explained further below, this can then provide a more flexible and configurable approach for implementing processing pipelines on graphics processors. For example, allowing the graphics processor to locally update its pipeline configuration information may also facilitate the graphics processor being able to populate its own command buffer, i.e. such that the graphics processor (e.g. a command stream frontend/job manager thereof) itself can determine some or all of the pipeline configuration information that is to be used to control the graphic processing pipeline execution.

To do this, according to the technology described herein, the graphics processor is operable and configured to issue suitable ‘state update commands’ to the processing pipeline to incrementally update some or all pipeline configuration information for the processing pipeline. The state update commands are then passed down the processing pipeline, such that they are seen (and processed) by each of the pipeline stages, and used to dynamically update the pipeline configuration information that is currently stored in association with, and usable to control execution of, the processing pipeline.

The technology described herein thus relates particularly to the updating of such pipeline configuration information, and the operation of the graphics processor to process such incremental state updates.

According to the technology described herein, the (current) pipeline configuration information is stored in association with, and locally to, the processing pipeline (i.e. the processing (shader stage) circuit(s)). Thus, a copy of the ‘full’ set of (current) pipeline configuration information, i.e. including any pipeline configuration information that relates to the processing pipeline as a whole, and also any portions of pipeline configuration information relating to the individual pipeline stages defining the processing pipeline, is stored in association with the processing pipeline as a whole.

When it is desired to update some or all of the pipeline configuration information ahead of a next instance of processing pipeline execution, a suitable one or more ‘state update’ commands can thus be (and are) issued into the processing pipeline to update the pipeline configuration information accordingly. The ‘state update’ command will then cause the relevant parts of the ‘full’ set of (current) pipeline configuration information that is stored in association with the processing pipeline as a whole to be updated.

For example, in embodiments, a copy of the ‘full’ set of (current) pipeline configuration information is stored in a suitable “post pipeline” stage that is in an embodiment (logically) located at the end of the processing pipeline.

A ‘state update’ command is thus issued into the processing pipeline, and passes down the processing pipeline such that the ‘state update’ command is processed by each of the pipeline stages of the processing pipeline. Once the ‘state update’ command has reached the end of the processing pipeline, i.e. once it has been processed by the last pipeline stage, and thus (fully) passed through the processing pipeline, the ‘state update’ command can then be passed to the “post pipeline” stage at the end of the processing pipeline and used to update the copy of the ‘full’ set of (current) pipeline configuration information that is maintained by the “post pipeline” stage for the processing pipeline as a whole.

The ‘state update’ commands according to the technology described herein should, and therefore do, always update the copy of the ‘full’ set of (current) pipeline configuration information that is stored for the processing pipeline as a whole, and this update is performed once the respective “state update” command has passed through the processing pipeline.

In other words, when it is desired to update some or all of the set of graphics pipeline state information, a corresponding ‘state update’ command to update the set of graphics pipeline state information is passed into the processing pipeline. The ‘state update’ commands in the technology described herein are thus passed through the processing pipeline, being processed by each of the pipeline stages as appropriate/needed, and once a ‘state update’ command has passed through the processing pipeline and out from the last pipeline stage, the copy of the full set of pipeline configuration information (e.g. that is stored in the “post pipeline” stage) can then be (and is) updated accordingly.

The “post pipeline” stage in an embodiment also then drains the state update command from the command buffer.

Thus, according to the technology described herein, the copy of the ‘full’ set of (current) pipeline configuration information that is stored for the processing pipeline as a whole is updated as a result of a corresponding ‘state update’ command passing all the way through the processing pipeline.

The copy of the ‘full’ set of (current) pipeline configuration information is thus only updated once the corresponding ‘state update’ command has passed through the processing pipeline in full. This then means that any earlier commands that are still being processed within the processing pipeline will still be able to see the ‘old’ version of the set of pipeline configuration information, such that the ‘state update’ command can be, and in an embodiment is, issued to the processing pipeline without waiting for any earlier commands that may still need to use the ‘old’ version of the set of pipeline configuration information to have drained from the processing pipeline.

In this respect, it will be appreciated that the ‘pipelined’ nature of the processing pipeline may, and in an embodiment does, effectively ensure the appropriate ordering requirements between consecutive commands as the processing pipeline can be (and is) configured to keep commands in order, such that a state update command will always remain behind any earlier commands that may still need the ‘old’ version of the set of pipeline configuration information.

(For instance, it may not generally be possible to broadcast an updated set of pipeline configuration information to all pipeline stages without waiting for all current commands to drain as this update may impact the processing of commands that are currently in-flight.)

The technology described herein thus in an embodiment enforces the desired ordering requirements between state updates and other commands, and this ordering is in an embodiment enforced for each pipeline stage.

Subsequent to a ‘state update’ command, one or more further commands may then (and typically will) be issued to the processing pipeline to perform processing work. For example, after issuing one or more ‘state update’ commands to update the pipeline configuration information, one or more draw calls may then be issued into the processing pipeline for processing, wherein the execution of the processing pipeline in respect of those draw calls is to use the updated pipeline configuration information.

The graphics processor could wait until the copy of the ‘full’ set of pipeline configuration information that is stored for the processing pipeline as a whole has been updated (i.e. until after the respective “state update” command has passed all the way through the processing pipeline) before issuing any further such commands to perform processing work into the processing pipeline, and this would ensure correct (safe) pipeline behaviour, e.g., since this would ensure that any state updates can be performed for all pipeline stages prior to any further commands being issued to any of those pipeline stages. However, this can introduce latency.

The Applicants thus recognise in this regard that so long as each pipeline stage has an up-to-date version of the pipeline configuration information that is relevant to that pipeline stage, it is possible to issue further following commands that may be affected by a previous state update into the processing pipeline without waiting for the ‘state update’ command to propagate all the way through the processing pipeline.

Thus, according to the technology described herein, an individual pipeline stage (and in an embodiment each of the individual pipeline stages) is operable and configured to separately maintain a local copy of (at least) a respective portion of the pipeline configuration information relating to that pipeline stage (and in an embodiment an individual pipeline stage maintains a local copy of only the respective portion of the pipeline configuration information relating to that pipeline stage, e.g. so that the local copy maintained by a particular pipeline stage does not contain any pipeline configuration information relating to any other pipeline stages).

In this respect, another effect and benefit of sending the ‘state update’ commands down the processing pipeline therefore is that the ‘state update’ command can (and will) be processed by each pipeline stage in turn before the copy of the ‘full’ set of (current) pipeline configuration information is updated.

This then means that each pipeline stage is able to update its respective local copy of its relevant portion of the pipeline configuration information as and when the ‘state update’ command is processed by that pipeline stage. The effect of this is that each pipeline stage can therefore (and does) maintain an up-to-date copy of any portions of the pipeline configuration information that is relevant to that pipeline stage, such that the pipeline stage can immediately process further commands using the updated pipeline configuration information without having to wait for the state update command to reach the end of the processing pipeline to update the copy of the ‘full’ set of pipeline configuration information that is stored for the processing pipeline as a whole.

In this respect, it will again be appreciated that the ‘pipelined’ nature of the processing pipeline may effectively ensure the appropriate ordering requirements between consecutive commands as the processing pipeline can be (and in an embodiment is) configured to keep commands in order, such that a state update command will always remain ahead of any following commands that may be affected by the state update.

The technology described herein can thus in embodiments provide an improved mechanism for updating pipeline configuration information in a more dynamic manner, in particular where incremental state updates can be performed locally to, and under the control of, the graphics processor (processing pipeline) (hardware), e.g. rather than requiring the main (host) processor to send a new copy of the ‘full’ set of preconfigured pipeline configuration information whenever any portion of the pipeline configuration information is to be updated.

Further, this can be, and is, done in such a manner to allow continued throughput of commands into the processing pipeline, thus in an embodiment reducing bubbles of processing pipeline inactivity that might otherwise be associated with performing such state updates.

The pipeline configuration information that is used/updated according to the technology described herein may in general comprise any suitable and desired pipeline configuration information, e.g. depending on the configuration of the processing pipeline in question.

For example, and generally, the pipeline configuration information that is used/updated according to the technology described herein may be any suitable pipeline ‘state’ information that may be (and is) used by the processing pipeline (or shader stage circuit(s) when implementing the same) to control the processing pipeline execution.

Thus, some of the pipeline configuration information may affect the processing pipeline as a whole, whereas some of the pipeline configuration information may relate to the control of specific pipeline stages.

Examples of such pipeline configuration information that specifically relates to particular pipeline stages may include, but are not limited to, an indication of a shader program or programs to be invoked by that pipeline stage, a job size for the shader program(s) being executed for that pipeline stage, etc. For the initial, first pipeline stage, such pipeline configuration information may also include information about the input data (e.g. an index array).

Examples of pipeline configuration information that relates to the processing pipeline as a whole may include, but are not limited to, depth flags, parameters for stencilling, scissoring, viewport, etc.

Various other examples would be possible in this regard, e.g. depending on the processing pipeline in question (and its desired configuration).

As mentioned above, each pipeline stage is operable and configured to process any such ‘state update’ commands to update pipeline configuration information and in particular to update their own local copies of the respective portion(s) of the pipeline configuration information that is relevant to them. That is, in an embodiment, each pipeline stage maintains only a copy of the portion of pipeline configuration information that is specifically relevant to that pipeline stage. Thus, if a ‘state update’ command affects the portion of pipeline configuration information that is relevant to a particular stage, that particular stage updates its copy of that portion of pipeline configuration information (but if the ‘state update’ command only affects that portion, the other pipeline stages for which that portion is not relevant, in an embodiment do not update their local copies).

To facilitate this, the set of ‘full’ pipeline configuration information is in an embodiment stored in a consistent format so that respective portions that affect different pipeline stages can be identified. For example, in embodiments, the set of ‘full’ pipeline configuration information comprises a graphics state vector storing a plurality of items of pipeline configuration information, with each item of pipeline configuration information having a respective, unique position within the graphics state vector. A ‘state update’ command can thus identify which item of pipeline configuration information is to be updated with reference to its position within the graphics state vector, and the individual pipeline stages can thus identify whether or not the ‘state update’ command affects pipeline configuration information that is relevant to them.

Various arrangements would be possible in this regard.

Some of the pipeline configuration information, especially where this can be stored using relatively smaller amounts of data, may be updated directly. That is, a data value can be directly indicated by a state update command and that (same) data value is then stored in respective copies of the pipeline configuration information, as appropriate.

Some items of pipeline configuration information may, however, be stored using a descriptor of that pipeline configuration information. That is, rather than transferring the data values directly, the data values may be stored in a suitable descriptor, to which a pointer is created to allow the data values to be transferred in when needed. Such descriptors may also in some cases need be used by other processing units within the graphics processor, such that the pipeline configuration information may need to be subsequently passed to other processing units within the graphics processor. For example, in the context of a geometry processing pipeline, some of the configuration information used by the processing pipeline for a draw call (e.g. scissoring parameters, viewport, etc.) may also need to be provided to the binning unit, as this information may also be used for the subsequent (post-geometry processing) processing of that draw call.

For any such pipeline configuration information for which a corresponding descriptor is stored, the descriptor is in an embodiment therefore stored in (external) memory. In some more traditional graphics processing arrangements, relatively ‘static’ descriptors of the pipeline configuration information are generated in advance, e.g. in software, and these do not change. However, this approach may not work well when the processing pipeline is able to dynamically update pipeline configuration information, i.e. in the manner according to the technology described herein.

Thus, according to embodiments of the technology described herein, the processing pipeline itself is also operable and configured to create/update any such ‘descriptors’ of relevant pipeline configuration information (i.e. by creating a ‘snapshot’ of the relevant pipeline configuration information in its current form), as and when needed. The processing pipeline can then write any such newly created descriptors to suitable memory locations such that they can be subsequently used by a next instance of processing pipeline execution (or passed on to other processing units), as desired.

Thus, in embodiments, when one or more state update commands are received to update pipeline configuration information for which a corresponding descriptor is stored in memory for use by a subsequent instance of processing pipeline execution, this is tracked, and prior to performing the subsequent instance of processing pipeline execution, information indicative of a new descriptor for the updated pipeline configuration information is created to allow the new descriptor to be written to memory.

It will be appreciated in this regard that there may be a sequence of plural state update commands that all update pipeline configuration information for which a corresponding descriptor is stored in memory, and so this tracking is in an embodiment done cumulatively, i.e. to accumulate any and all such updates.

In an embodiment, therefore, when a subsequent command to trigger the next instance of processing pipeline (i.e. that requires a descriptor for the updated pipeline configuration information), prior to performing the subsequent instance of processing pipeline execution, a new descriptor can then be, and in an embodiment is, created for storing the updated pipeline configuration information, if needed, which new descriptor can then be written out to memory, and a suitable pointer to that new descriptor created for the next instance of processing pipeline.

That is, in embodiments, such ‘descriptors’ can be, and in an embodiment are, created and managed dynamically by the graphics processor (processing pipeline) (hardware) as and when state updates are seen (e.g. rather than ‘static’ descriptors of the set of ‘full’ pipeline configuration information being provided to the graphics processor, e.g. by the main (host) processor that is using the graphics processor).

To do this, the processing pipeline (processing (shader stage) circuit(s)) are in an embodiment operable to identify when a given state update command affects an item of pipeline configuration information for which a descriptor is to be stored in memory, and to track any such updates when they occur. This is in an embodiment done by an initial ‘state manager’ circuit associated with the processing pipeline. For example, the initial ‘state manager’ circuit may be logically positioned at the top of the processing pipeline so that any (state update) commands are first processed by the initial ‘state manager’ circuit before they are passed to the next (i.e. first) pipeline stage of the processing pipeline.

The initial ‘state manager’ circuit is thus in an embodiment operable and configured to identify and track any state updates (commands) that update pipeline configuration information for which a descriptor is to be stored in memory, and accumulate any such updates. Prior to performing a next instance of processing pipeline execution (e.g. for a particular draw call) that may need the updated pipeline configuration information, a suitable descriptor should thus be created, if needed, containing any such state updates, and this new descriptor should be stored in memory appropriately, e.g. so that it can be used by the next instance of processing pipeline execution, as required.

For example, an instance of processing pipeline execution is in an embodiment triggered by a respective command (which may, e.g., be a specific ‘RUN_PIPELINE’ command to trigger an instance of the processing pipeline execution for one or more draw calls, as will be discussed further below, but could be any other suitable command that is able to trigger an instance of processing pipeline execution, such as a ‘full screen’ draw command). When a new such command is executed, this can then trigger the ‘state manager’ circuit to create, as necessary, a respective new descriptor based on any state updates seen since the previous instance of processing pipeline execution (i.e. the previous draw call). This descriptor can then be written out for use by the next instance of processing pipeline execution (i.e. that triggered the creation of the descriptor) (and also for use by any other processing units (stages) of the graphics processor that may need that information), as desired.

A ‘descriptor’ may generally be used for storing (and may thus be created in respect of) any suitable subset of pipeline configuration information. Further, the processing pipeline may be operable and configured to create multiple different ‘descriptors’, e.g. each containing a different subset of pipeline configuration information. For example, certain items of the pipeline configuration information may be expected to change together, such that those items of the pipeline configuration information are expected to have a similar lifetime within the graphics processing flow.

Therefore, it may be more efficient to try to group such items of the pipeline configuration information that are expected to have a similar lifetime within the graphics processing flow together and create a single descriptor that applies to all of those. However, it may be efficient to create another descriptor for another group of pipeline configuration information items that are expected to have a different lifetime within the graphics processing flow. This can then increase the likelihood that a given descriptor can be re-used (and in an embodiment reduce instances of having to create new descriptors).

In this respect, the Applicants have found that the same descriptors may be repeatedly used between draw calls. For example, an item of pipeline configuration information can often be updated multiple times but wherein successive updates reverse the previous update. It can also often be the case that an item of pipeline configuration information alternates between different states (e.g.) so that every other draw call uses the same pipeline confirmation.

Thus, when one or more state update commands are received to update pipeline configuration information for which a corresponding descriptor is stored in memory for use by a subsequent instance of processing pipeline execution, as discussed above, this may trigger the creation of information indicative of a new descriptor for the updated pipeline configuration information, which information can then be used to create the full descriptor and write the newly created descriptor to memory. In an embodiment, however, prior to creating any new descriptors in full and writing out any such newly created descriptors to memory, the technology described herein attempts to identify instances where the newly created descriptor(s) would be equal to descriptor(s) that are already stored in memory, e.g. to try to avoid writing equal descriptors, and hence save storage/internal bandwidth.

Thus, in embodiments, prior to writing out a descriptor for any updated pipeline configuration to memory, it is determined whether the new descriptor would correspond to a descriptor that is already stored in memory, and when it is determined that the new descriptor corresponds to a descriptor that is already stored in memory, the information indicative of the new descriptor (i.e. the information that can be used to create the new full descriptor) is discarded without creating the full descriptor or writing any of this information to memory. Thus, in the case where a new descriptor would correspond to an existing descriptor, rather than creating a new descriptor and writing out the newly created descriptor to memory, a pointer to an existing descriptor is instead updated/created for the subsequent instance of processing pipeline (such that the subsequent instance of processing pipeline uses the existing descriptor). This then saves bandwidth associated with creating and writing out the new descriptor when the new descriptor would correspond to a descriptor that is already stored in memory.

The determining whether the newly created descriptor would correspond to a descriptor that is already stored in memory may be done in any suitable and desired manner.

In an embodiment, this is done using only a subset of the pipeline configuration information that would be included in the full descriptor. That is, in embodiments, this is done based on a subset of the updated pipeline configuration information, i.e. using some information indicative of the new descriptor (and in that case, when a new descriptor is required to be created, further processing of that information may thus be performed, e.g. to pad, the full descriptor).

Various arrangements would be possible in this regard.

The actual determination that is performed using the information indicative of the new descriptor can be performed in any suitable and desired manner.

For example, in some embodiments, this could be done by maintaining a suitable descriptor cache (or buffer) of a previous N descriptors that have been created. Whenever it is determined that a new descriptor potentially needs to be created, information indicative of the new descriptor can thus be checked against corresponding information associated with the previous N descriptors in such cache (buffer), and if a corresponding (equal) descriptor already exists in memory, the information indicative of the newly created descriptor can be discarded at that point and the existing descriptor can be used instead. Otherwise, if the required (new) descriptor is not already present in the cache (buffer), the new descriptor is created, written to memory, and then added to the descriptor cache (buffer).

This approach can generally work well. However, the Applicants recognise that a descriptor can be relatively large, and maintaining such a descriptor cache (buffer) can therefore require relatively higher silicon area cost.

Thus, in embodiments, rather than storing the descriptors (or at least some information indicative of the descriptors) in full in such a descriptor cache (buffer), the determining is in an embodiment performed based on suitable values that are calculated based on some or all of the descriptors, and which can be used to check whether or not a new descriptor matches a descriptor that is already stored. Thus, the descriptor cache (buffer) in an embodiment stores such values, rather than storing full descriptors. This can accordingly reduce silicon area requirements (or, conversely, allow a larger number of descriptors to be stored) compared to using the descriptors in full.

Thus, the determining whether the new (to be created) descriptor corresponds to (i.e. is equal to) a descriptor that is already stored in memory in an embodiment comprises checking a respective value (e.g. a checksum/hash) calculated based on some or all of the information indicative of the new descriptor with corresponding (checksum/hash) values calculated for one or more descriptors that are already stored in memory.

The respective (checksum/hash) values that are used may be selected according to any suitable algorithm. Various known hashing or checksum algorithms or data structures may be used in this regard. Generally, the hashing or checksum algorithms/structures should be selected so that there is no risk of determining that a descriptor is already present in memory when it in fact is not (i.e. there are no false positives), but false negatives may be permitted, as this simply means that a descriptor may be unnecessarily written out.

Similarly, and as alluded to above, the respective (checksum/hash) values that are used may be calculated over any suitable set of the pipeline configuration information contained within a descriptor. In an embodiment, this is done in such a manner to reduce chances of hash collisions. For example, certain items of pipeline configuration information may be expected to change more frequently, and so it may be preferred to include at least those items in the calculation. However, other items of pipeline configuration information may not be expected to change between draw calls, and so, to further reduce area (cost), these may be excluded from the calculation (although in that case, if an item of pipeline configuration information not included in the calculation does change between draw calls, the cache may need to be cleared to avoid collisions).

Various arrangements would be possible in this regard.

The ‘state manager’ circuit is thus responsible for creating such descriptors as needed. Once a ‘state update’ command has been processed by the ‘state manager’ circuit it is then passed to the next (i.e. the first) pipeline stage of the processing pipeline (and processed as described above).

In some cases, it may be desired to suspend an instance processing pipeline execution, e.g. in order to allow the graphics processor to start another instance of processing pipeline execution. In this case, the suspending of the processing pipeline execution is in an embodiment performed in a controlled manner to allow the instance of processing pipeline execution to subsequently be resumed, in an embodiment from the point at which it was suspended.

For instance, it is becoming increasingly common for graphics processors to be used in data processing systems in which the graphics processor is, in effect, shared between multiple applications running concurrently.

In such cases, a graphics processor may be generating a render output for a first application, but then be required to switch to producing a render output for another application before it has completed the first render output. In that case therefore, the graphics processor will be required to suspend its processing of the first render output, so as to be able to switch to generating the second render output, but this is in an embodiment done in such a way that the graphics processor can then subsequently resume the processing of the first render output when the graphics processor returns to performing processing for the application that requires the first render output.

According to the technology described herein, because each pipeline stage maintains its own local copy of at least some of the pipeline configuration information, it may not be simply possible to store the copy of the ‘full’ set of pipeline configuration information and resume execution of the processing pipeline on that basis. It would in principle be possible, in addition to storing the copy of the ‘full’ set of pipeline configuration information, to also store out the local copies maintained by each pipeline stage, but this of course requires storing more data and may require complex mechanisms for tracking which commands are currently in-flight and which pipeline stages have processed those commands, etc.

Thus, in embodiments, when it is desired to “suspend” an instance of processing pipeline execution, this is in an embodiment done by (immediately) stopping issuing any new commands to the processing pipeline, and then storing the copy of the ‘full’ set of pipeline configuration information that is maintained for the processing pipeline as a whole at the point at which the processing is to be suspended, but also storing an indication of any (and all) commands that are currently being processed within the graphics processing graphics processor receiving a command to suspend its current processing pipeline. Thus, the suspend mechanism that is triggered, e.g., in response to the graphics processor receiving a command to suspend its (current) processing, in an embodiment stores a copy of the ‘full’ set of pipeline configuration information at the point at which the processing is to be suspended, together with information identifying any (and all) commands that were being processed within the graphics processing graphics processor at that point.

The information identifying any (and all) commands that were being processed within the graphics processing graphics processor at that point can be determined in any suitable and desired manner. For instance, as mentioned above, it is in an embodiment the “post pipeline” stage that drains the commands from the command buffer (such that commands are only drained once they have reached the end of the processing pipeline). Thus, in such embodiments, the information identifying any (and all) commands that were being processed within the graphics processing graphics processor at the point at which processing was suspended are in an embodiment just the commands still in the command buffer.

Various other arrangements would however be possible in this regard.

When it is desired to subsequently “resume” processing that has been suspended in this way, this can therefore be done by issuing to the processing pipeline a respective state update command including the set of ‘full’ pipeline configuration information that was stored at the point at which the processing was suspended to rebuild the copy of the set of ‘full’ pipeline configuration information. After this state update command has been issued to the processing pipeline, any (and all) commands that were being processed within the graphics processing graphics processor at the point at which processing was suspended are then issued to the processing pipeline (in the same order that they were originally issued). This then allows the processing pipeline to be returned to its state at the point at which the processing was suspended, and from that point, processing may continue as normal, e.g. by issuing any further commands that should be issued.

Thus, in embodiments, in response to a command to suspend a current instance of processing pipeline execution, the current instance of processing pipeline execution is suspended by:
stopping issuing any new commands to the processing pipeline;
saving a copy of the full set of pipeline configuration information that is stored in association with the processing pipeline as a whole; and
saving information indicative of any commands that are currently being processed within the processing pipeline.

Subsequently, in response to a command to resume an instance of processing pipeline execution that has been previously been suspended, the instance of processing pipeline execution can be resumed by:
issuing into the processing pipeline one or more state update command(s) including the copy of the full set of pipeline configuration information that was saved at the point at which the instance of processing pipeline execution was suspended; and then
issuing any commands that were being processed within the processing pipeline at the point at which the instance of processing pipeline execution was suspended into the processing pipeline in the same order they were originally issued.

The suspend/resume mechanism may otherwise generally be performed in any suitable and desired manner (and various suspend/resume mechanisms exist that may suitably be used in this regard).

The technology described herein can therefore provide a more efficient, and dynamic, mechanism for updating the pipeline configuration information that is used to control the operation of a processing pipeline, with the updating in an embodiment being performed by, and under the control of, the graphics processor (processing pipeline) (hardware), e.g. rather than relying on static updates being sent from the main (host) processor that is using the graphics processor.

The technology described herein may therefore provide various benefits compared to other possible approaches.

Subject to the particular requirements of the technology described herein, the graphics processor (and processing pipeline) may otherwise be operated and configured in any suitable and desired manner.

In embodiments, the processing pipeline can be, and is, executed by a set of ‘generic’ (programmable) pipeline stages that can be configured to map to a corresponding set of desired (different) stages of a processing pipeline to be executed. This configuration of the (generic) pipeline stages can thus be, and in an embodiment is, performed in advance of, and for, a particular instance (or number of instances) of processing pipeline execution, e.g. prior to issuing any work to the processing pipeline for the particular instance(s) of processing pipeline execution. The processing pipeline, once configured, can then be executed accordingly to process “packets” of work items to generate an overall pipeline output.

The processing pipeline that can be (and is) executed by a graphics processor according to the technology described herein is thus in an embodiment hardware-implemented (e.g. rather than being executed entirely in software, e.g. using general purpose computer shaders, which may be less efficient), but the processing pipeline (hardware) is in an embodiment configured in software, and can therefore in an embodiment also be re-configured in software, as desired, e.g. for different instances of processing pipeline execution (e.g. between render passes, or even within a render pass (e.g. between draw calls)).

This can then provide a more flexible and configurable approach as the ‘generic’ pipeline stages can be configured and used to support various different graphics processing flows (including, for example, more advanced geometry processing flows, e.g. utilising task/mesh shaders, tessellation shaders, transform feedback, etc.) and this is in an embodiment done using the same, underlying (generic) pipeline stage hardware (circuitry) but with the pipeline stages triggering different (shader) program execution depending on the particular configuration of the pipeline stages defining the processing pipeline. For example, a desired graphics processing flow can be suitably mapped onto a processing pipeline, with the pipeline stages (hardware) then being configured and programmed appropriately in advance of one or more instances of processing pipeline execution to support that graphics processing flow. In this way, the same underlying hardware (circuits) may be used to support multiple, different graphics processing flows.

Thus, as mentioned above, the graphics processor according to the technology described herein thus includes one or more processing circuits (referred to herein as “shader stage circuits”) that can be used to implement a set of ‘generic’ pipeline stages (wherein, as mentioned above, each generic pipeline stage of the set of generic pipeline stages can be configured as a respective, different shader stage to be executed as part of a processing pipeline).

Each (generic) pipeline stage is in an embodiment operable in common to perform a particular (same) sequence of processing operations in response to an incoming packet of work items (although it will be appreciated that different pipeline stages may or may not actually perform these operations, e.g. depending on how the pipeline stage is configured and/or the type of packet that is to be processed).

The pipeline configuration information that is used to control the processing pipeline and that can be updated according to the technology described herein may thus include information indicative of which pipeline stages are to be executed, which shader program or programs are to be executed in respect of which pipeline stages, etc.

The technology described herein can be used for all forms of output that a graphics processor and processing pipeline may be used to generate. In particular, the technology described herein may be used both for generating graphics processing outputs, such as frames for display, render to texture outputs, etc., or for general purpose (non-graphics) outputs.

As will be appreciated by those skilled in the art, the graphics processor can otherwise include and execute, and in an embodiment does include and execute, any one or one or more, and in an embodiment all, of the pipeline stages and circuits that graphics processors and processing pipelines may (normally) include.

Thus, for example, the graphics processor may execute a processing pipeline that includes one or more geometry pipeline stages, such as vertex shading, task shading, mesh shading, tessellation shading, etc., and execute one or more rendering stages, such as rasterisation and fragment shading stages, and/or appropriate ray tracing stages. In an embodiment the graphics processor is in the form of a tile-based graphics processor and so also includes and executes an appropriate tiling/binning stage or stages.

Correspondingly, the graphics processor may include any one or more of, and in an embodiment plural of: one or more geometry processing circuits, primitive assembly circuit or circuits, a tiling/binning circuit or circuits, a primitive setup circuit, a rasteriser circuit and a renderer circuit (in an embodiment in the form of or including a programmable fragment shader), a depth (or depth and stencil) tester, a blender, a tile buffer, a write out circuit, etc.

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus it may comprise, for example, a tile to be generated in a tile based graphics processing system, and/or a frame of output fragment data. The technology described herein can be used for all forms of output that a graphics processor and processing pipeline may be used to generate, such as frames for display, render-to-texture outputs, etc. In an embodiment, the output is an output frame, and in an embodiment an image. However, in general the graphics processors (and processing pipelines) of the technology described herein may be used both for performing graphics processing work, such as generating frames for display, etc., or for performing general purpose (non-graphics) work, as desired.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, and stages, of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various pipeline stages may share processing circuitry/circuits, etc., if desired.

Furthermore, unless otherwise indicated, any one or more or all of the pipeline stages of the technology described herein may be embodied as pipeline stage circuits, e.g., in the form of one or more fixed-function units (hardware) (processing circuits), and/or in the form of programmable processing circuits that can be programmed to perform the desired operation. Equally, any one or more of the pipeline stages and pipeline stage circuitry of the technology described herein may be provided as a separate circuit element to any one or more of the other pipeline stages or pipeline stage circuits, and/or any one or more or all of the pipeline stages and pipeline stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

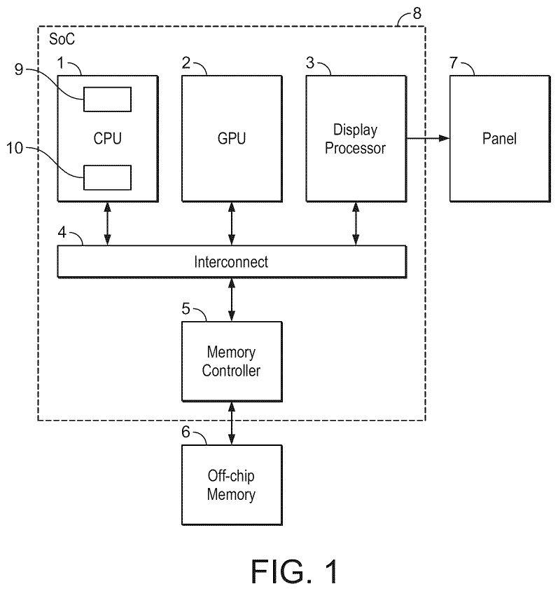

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

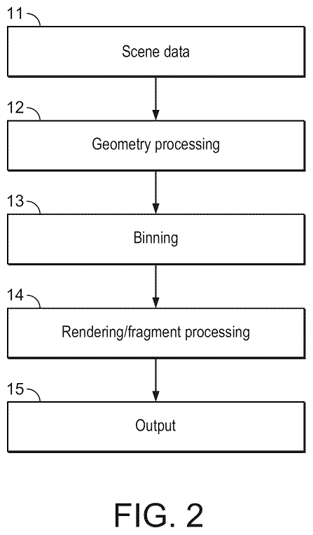

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry pipeline stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 2, a binning/tiling stage 13. (It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.)

The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment pipeline stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.

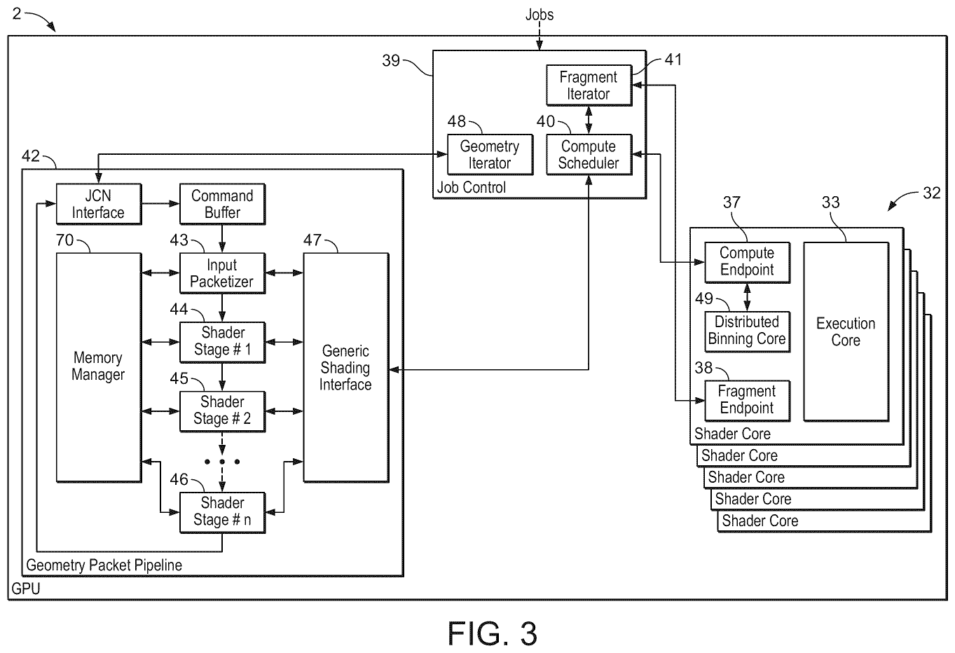

FIG. 3 shows an embodiment of a graphics processor (GPU) 2 that can execute a graphics processing pipeline of the form shown in FIG. 2, and that can be operated in the manner of the technology described herein.

As shown in FIG. 3, the graphics processor 2 comprises a plurality of processing (shader) cores 32 which are each operable to execute (shader) programs to perform processing operations. As shown in FIG. 3 each shader core 32 to facilitate this comprises a programmable execution unit (execution core) 33 that is operable to execute program instructions to perform processing operations.

Each execution core 33 has appropriate access to a memory system 6 of the data processing system that the graphics processor 2 is part of via a pair of hardware-controlled buffers 35, 36.

In the present embodiments, the shader cores 32 are operable to execute both “compute” shader programs (to perform so-called compute shading) and fragment shader operations. Thus as shown in FIG. 3, each shader core 32 comprises an appropriate compute endpoint 37 and fragment endpoint 38 that act as the control interface for performing compute shading and fragment processing, respectively, and that will, for example, and in an embodiment, trigger the execution core 33 to execute the appropriate compute shading or fragment shading tasks, as required.

As shown in FIG. 3, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing pipeline stage determines the vertex and other data that is necessary for generating the graphics processing output in question, which will then be followed by a rendering/fragment pipeline for processing (rendering) that geometry.

In the present embodiments, the geometry processing is performed, as shown in FIG. 3, by a geometry packet pipeline 42 of the graphics processor 2. This geometry packet pipeline is operable to trigger the performance of one or more “geometry” shader stages (which shader stages themselves will be executed by the shader cores 32, under the control of the geometry packet pipeline 42).

For example, as shown in FIG. 3, the geometry packet pipeline 42 comprises an input packetizer 43 that can trigger position shading and vertex shading 50 by the shader cores 32. It also includes further shader stage circuits 44, 45, 46 that are operable to trigger compute shaders 5 for performing geometry processing, such as task shaders, mesh shaders, tessellation shaders, etc., (which again will be executed by the shader cores 32).

As shown in FIG. 3, the geometry packet pipeline 42 has an appropriate interface 47 to the compute scheduler 40 of the job control unit 39, via which it can control and trigger the performance of appropriate geometry shading operations by the shader cores 32.

The overall operation of the geometry packet pipeline 42 is controlled by the job control unit 39 (by a geometry iterator 48 of the job control unit 39) which distributes the appropriate geometry processing jobs and tasks to the geometry packet pipeline 42.

The graphics processor 2 of FIG. 3 is configured to perform rendering in a tile-based manner (as discussed above). To facilitate this, as shown in FIG. 3, each shader core 32 also includes a distributed binning core 49 that is operable to generate appropriate data structures for determining which primitives need to be processed for respective rendering tiles of the output being generated.

In the present embodiments, the distributed binning cores 49 generate hierarchies of bounding boxes for primitives and primitive packets (that contain primitives to be rendered) (which are then used at the rendering/fragment pipeline stage to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

As shown in FIG. 3, the distributed binning cores 49 of the shader cores 32 may trigger vertex shading 53, such as varying shading, as part of their operation (e.g. where varying shading was not performed by the input packetizer as part of the input packetizer 43 operation).

In the present embodiments, the rendering/fragment processing is performed by executing appropriate fragment processing operations on a shader core 32 under the control of the fragment endpoint 38. To facilitate this, as shown in FIG. 3, the fragment endpoint 38 of each shader core is operable to trigger appropriate fragment shader operation 52 by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes (which data can be respectively considered to be corresponding data elements (e.g. positions or varyings, in the case of vertices) for corresponding work items (e.g. vertices)), which data will then be used, for example, by the binning/tiling processing and rendering/fragment processing of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then used by the fragment processing (fragment shaders) 52.

Thus, in the present embodiments, the geometry packet pipeline 42 will generate work item packets, in the form of geometry packets, that store data elements (attributes) for work items (such as vertices and primitives), which geometry packets will then be read and used by the distributed binning cores 49. Correspondingly, the distributed binning cores 49 will generate appropriate primitive packets storing data elements (attributes) for work items, such as vertices and primitives, which primitive packets will then be read and used by the fragment processing 38.

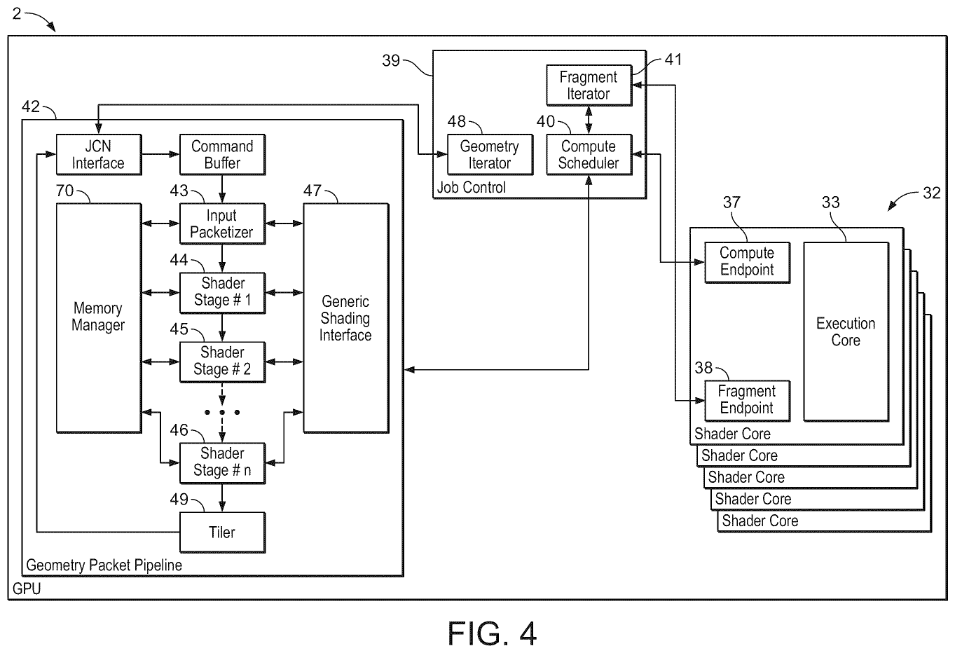

Various other arrangements would of course be possible. For example, rather than the geometry packet pipeline 42 generating geometry packets that are then read and used by the distributed binning cores 49 as shown in FIG. 3, the geometry packet pipeline 42 could interface and provide geometry packets to a tiling unit 59 that then performs more traditional tiling operations, e.g. in the normal (serialized) manner for tile-based graphics processing, using the geometry packets. An example of this is shown schematically in FIG. 4.

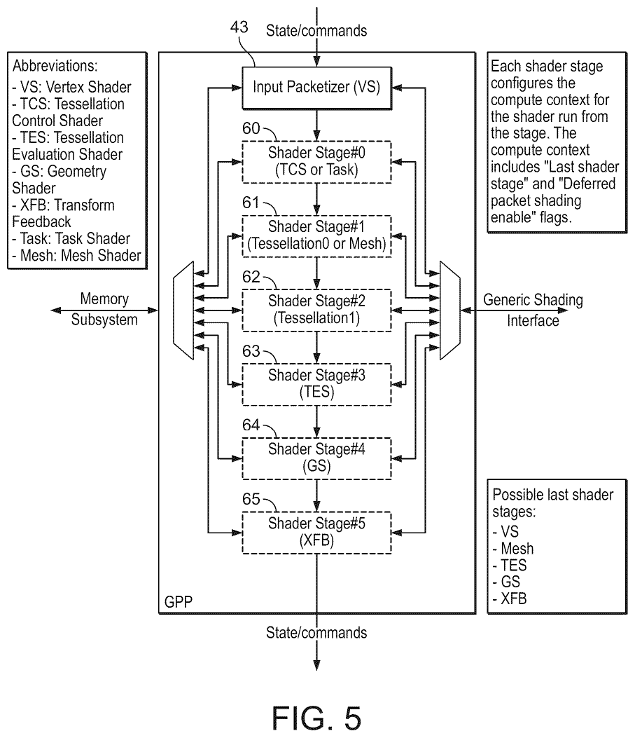

FIG. 5 shows an example of a geometry packet pipeline 42 that may be executed according to the present embodiments in more detail.

As shown in FIG. 5 in the present embodiments, the geometry packet pipeline 42 comprises (can trigger the execution of) six shader stages, an input packetizer 43 (can trigger vertex shading (VS)) a next shader stage 60 that can trigger tessellation control shading or task shading, a next shader stage 61 that can trigger tessellation shading or mesh shading, a next shader stage 62 that can trigger further tessellation shading, a next stage or stage 63 that can trigger tessellation evaluation shading, a next stage or stage 64 that can trigger geometry shading, and a final shader stage 65, that can trigger transformed feedback shading.

In operation, each shader stage of the geometry packet pipeline 42 will configure the compute context for the shader that is run from the stage in question.

In the present embodiments, as will be explained further below, when executing the geometry packet pipeline for a render output (e.g. for a draw call), the various shader stages shown in FIG. 5 can be selectively enabled. In other words, not every execution of the geometry packet pipeline 42 will include all the shader stages shown in FIG. 5, but selective shader stages can be omitted from the geometry packet pipeline 42 that is being executed.

Thus, the geometry processing pipeline 42 may comprise multiple pipeline stages of different types, namely an input packetizer 43, one or more shader stages 60-61-62-63-64-65 that can be implemented using generic shader stage circuits 44, 45, 46, and optionally a packet primitive drain unit (e.g. implemented as part of a tiler unit 59 as shown in FIG. 4).

As mentioned above, the input packetizer 43 reads the index array and builds packets that can be used by the rest of the pipeline. Thus, in the present embodiments, the only shading that can be (and is) invoked by the input packetizer 43 is vertex shading (which can be position-only vertex shading or combined position and varyings shading). The input packetizer 43 can also be selectively disabled and/or enabled without shading and populated with (pre-shaded) input vertices. Various arrangements would be possible in this regard depending on the particular processing operations to be performed.

Once a packet has been fully populated by the input packetizer 43 (when this is done), the packet is sent to the next stage in the geometry processing pipeline 42 which then processes the incoming packet, and performs any desired shading, e.g. as described above. Thus, as described above, the geometry processing pipeline 42 further includes a plurality of shader stages 60-61-62-63-64-65 that are implemented using generic shader stage circuits 44,45, 46 that can be, and are, dynamically configured in advance of geometry processing pipeline 42 execution as respective shader stages to perform the desired pipeline operations.

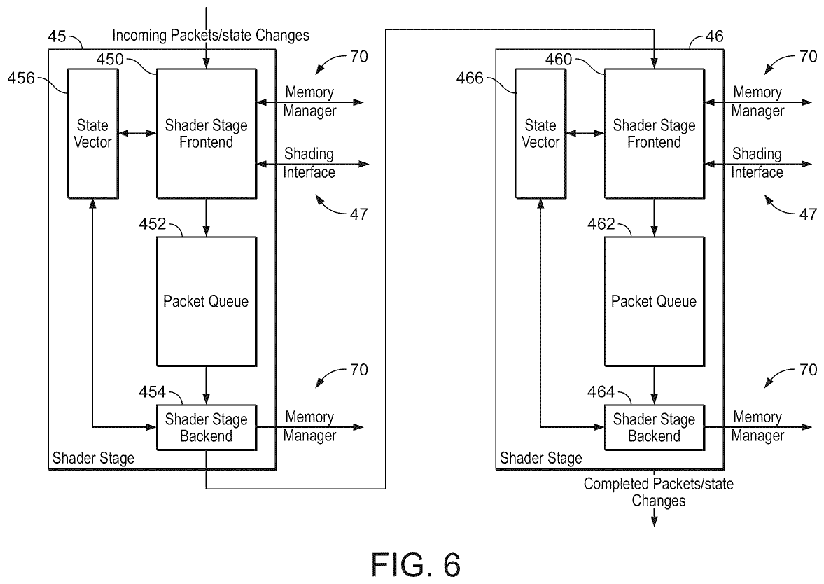

FIG. 6 shows in more detail the shader stage circuits 44, 45, 46 of the geometry packet pipeline 42. In particular, FIG. 6 shows two of the shader stage circuits 44, 45, 46 connected together to illustrate how data can flow along the geometry packet pipeline 42 through a shader stage circuit and onto the next shader stage circuit.

As shown in FIG. 6, the shader stage circuits 44, 45, 46 are operable to receive (either from the input packetizer 43 or from a previous shader stage circuit in the geometry packet pipeline 42) incoming packets/state changes to be processed. The incoming packets/stage changes are then processed within a shader stage frontend circuit 450, 460 that, as will be explained further below, interfaces and communicates with a memory manager 70 and generic shading interface 47 of the geometry packet pipeline 42. The shader stage frontend circuit 450, 460 is operable to output packets into a respective packet queue 452, 462 that is maintained by each shader stage circuit 44, 45, 46 and packets can be processed from the respective packet queue 452, 462 by a shader stage backend circuit 454, 464 that as shown (e.g.) in FIG. 5 is operable and configured to pass packets on to the next shader stage circuit within the geometry packet pipeline 42.

Packets/state changes can thus be passed through the shader stage circuits 44, 45, 46 and onto the next the shader stage circuits 44, 45, 46, and so on, until they have reached the end of the geometry packet pipeline 42.

As shown in FIG. 6, each shader stage circuit 44, 45, 46 may be, and in the presents embodiments is, ‘generic’, i.e. in that it is capable of performing the same underlying basic processing operations. This then means that the shader stage circuits 44, 45, 46 may be implemented generically in hardware with the different processing operations being controlled based on suitable software configuration of the shader stage circuits 44, 45, 46 based on the overall (desired) configuration of the geometry packet pipeline 42. It will be appreciated however that a given shader stage circuit may or may not actually perform these processing operations, e.g. depending on how the shader stage circuit is configured and/or the type of packets that it is processing.

Thus, as will be explained further below, there may be an initial configuration of the geometry packet pipeline 42 in which the respective shader stage circuits 44, 45, 46 are configured to perform the desired processing operations (and this initial configuration may be performed in advance, e.g. per render pass). Subsequent state changes may also be passed down the geometry packet pipeline 42 to update/set state as needed, e.g. between draw calls.

As shown in FIG. 6, each shader stage circuit 44, 45, 46 may thus have access to a local copy of a state vector 456, 466 that stores configuration state for the shader stage circuit in question, including, for example, an indication of the type of shading requests that are to be triggered by that shader stage circuit.

This can therefore provide a more flexible approach for supporting different types of shader operations as required.

In this respect, it will be appreciated that although the various shader stage circuits 44, 45, 46 are depicted as separate stages, and at least from a logical perspective are treated as separate stages defining the geometry packet pipeline 42, the shader stage circuits 44, 45, 46 may and in some embodiments do share physical hardware circuitry. That is, in general, there may be, and typically will be, fewer physical stages implemented in hardware than there are logical stages within the geometry packet pipeline 42, with the same hardware being configured/re-configured to implement different logical stages, as desired. In an embodiment, there are at least two separate, physical circuits available to implement the different pipeline stages (to allow some parallelisation/overlap of pipeline stages), but in principle there could only be a single physical circuit that is used to support all of the pipeline stages, with the data flow between pipeline stages being managed appropriately, e.g. based on the memory pool allocations, etc.

The geometry processing pipeline 42 may also include at the end of the geometry processing pipeline 42 a suitable packet draining unit that drains the fully processed packets from the geometry processing pipeline 42.

For example, as shown in FIG. 4, the geometry processing pipeline 42 may interface with, and connected to, a tiling unit 59 that pulls fully processed packets from memory, writes fully processed packets to on-chip payload storage, drains the packet, and assembles primitives from the processed packets. The tiling unit 59 may perform visibility culling of the primitives, but any visible primitives can then be (and are) drained in order from the packet and sent on to the tiler pipeline (not shown). The Tiler pipeline may then perform bounding box culling and binning of the primitives and outputs vertex data and polygon lists necessary for the fragment shading, e.g. in the normal manner for such tiling operations.

Alternatively, as shown in FIG. 3, and described above, the draining of packets may be performed by the distributed binning cores 49.

Various arrangements would be possible in this regard for draining fully processed packets from the geometry processing pipeline 42.

When work is to be performed using the geometry packet pipeline 42, this is in an embodiment triggered by executing a suitable instruction (e.g. a ‘RUN_PIPELINE’ instruction, as will be explained further below), and execution of such instruction causes work to be launched on the first enabled stage in the geometry processing pipeline 42. This first stage may be the input packetizer 43 or a subsequent shader stage depending on the particular operations to be performed (e.g., and in particular, whether the input packetizer 43 is present/enabled).

The first stage requests from the memory manager 70 to allocate a packet in a respective memory pool tied to the first stage. If allocation succeeds, the first stage then issues a shading request via its generic shading interface 47 in respect of the packet to the compute scheduler 40 within the job control unit 39 of the graphics processor 2, which computer scheduler 40 then schedules a corresponding one or more processing tasks to respective compute endpoints 37 of the shader cores 32. The shader program run on the packets issued by a particular stage is in the present embodiments defined by a unique shader program descriptor for the stage, which is configured as part of the initial pipeline configuration.

Consecutive packets issued for shading are thus distributed to available shader cores 32 in this way with the packet shading being controlled via the compute shader scheduler 40 (and compute endpoints 37).

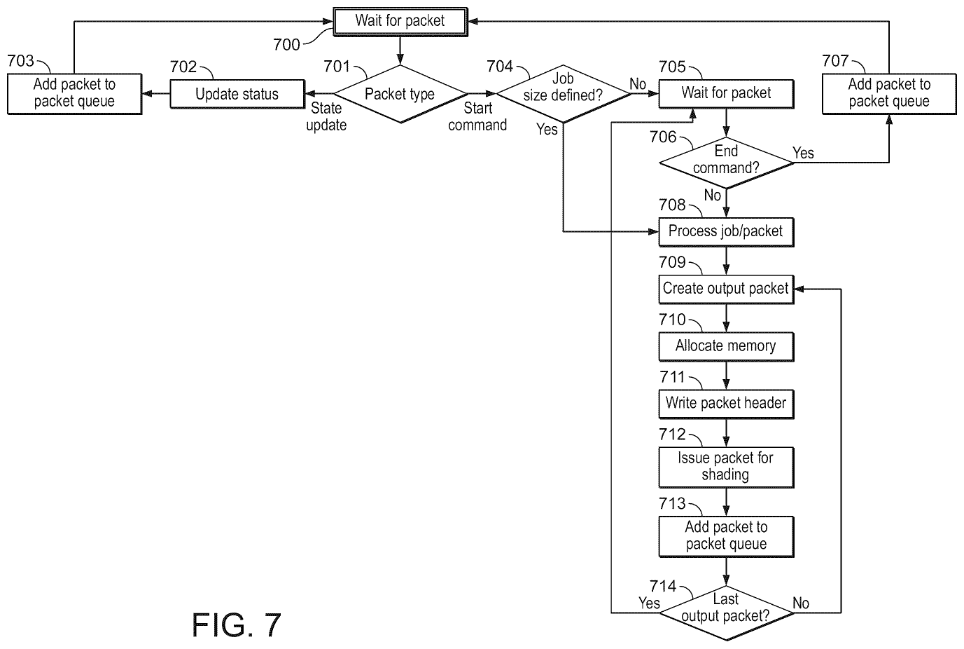

FIG. 7 is a flow chart showing the shader stage frontend operation in more detail. As shown in FIG. 7, packets of work items to be processed and packets of state are both passed through the pipeline stages in a similar manner. Thus, the shader stage frontend waits for a new packet to be received (step 700), and then determines whether packet includes a packet of work items to be processed or whether the packet includes a state update (step 701). For state updates, the relevant state is updated (step 702), and the packet is then added to the packet queue (step 703) so that the state update can be passed on to the next pipeline stage. This then allows state updates can be propagated through the pipeline stages to allow the graphics processing pipeline to be appropriately updated/re-configured for different instances of graphics processing pipeline execution (this will be discussed in more detail below).

For packets of work items, the shader stage frontend first checks whether the job size is defined (step 704), i.e. whether the shader stage has the information needed to process the packet of work items. If not (step 704—no), the shader stage frontend may wait for further packets for the current job (step 705). If a packet containing a suitable ‘end command’ indicating that the current job is finished (i.e. all packets for all draw calls for that job have been processed) is received (step 706—yes), the packet can be added to the packet queue (step 707) so that the ‘end command’ can be passed on to the next pipeline stage. Otherwise, once the job size is defined (step 704—yes), or so long as an ‘end command’ is not received such that there are further packets to be processed for the current job (step 706—no), the shader stage frontend then proceeds with processing further packets for the current job (step 708). The packet processing in the shader stage frontend is performed as follows.

Firstly, the shader stage frontend determines from the packet header (i.e. including the packet metadata) how many (if any) output packets should be generated from the incoming packet, and creates a corresponding (first) output packet (step 709).

The output packet is then processed by the shader stage frontend messaging the memory management system to allocate a respective portion of the memory pool tied to the current pipeline stage (step 710), and writing the respective packet header to that portion of the memory pool (step 711). The packet is then issued for shading (step 712) and added to the packet queue for the current pipeline stage (step 713). This is then repeated until all of the desired output packets have been created and added to the packet queue (i.e. following the ‘step 714—no’ loop).

Once all of the output packets created from a respective incoming packet have been processed in this way (step 714—yes), the shader stage frontend then waits for the next incoming packet (step 705) from the current job, which is then processed in the same way. Once all of the packets for the current job have been processed (i.e. the ‘end command’ is received (step 706)), the job is finished and the shader stage frontend waits for the next packet (step 700) (i.e. for a next job).

Thus, the shader stage frontend is configured to issue packets for shading (i.e. step 712) and maintain a respective packet queue including the packets that are currently being processed by the shader stage in question.

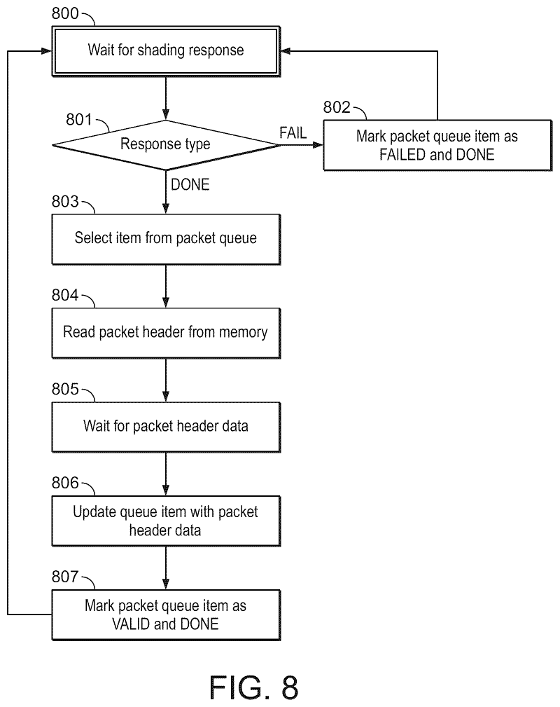

FIG. 8 is a flow chart showing how packets are updated in the packet queue. Note that this process is asynchronous to the shader stage frontend operations. Thus, the shading of packets may complete out of order, but the packets are nonetheless kept in order in the packet queue (and provided in this same order for output to a next pipeline stage).

Thus, as shown in FIG. 8, after a packet has been issued for shading, the pipeline stage should then wait for a shading response to be received (step 800). If the response is that the shading has failed (step 801—fail), that packet is marked in the packet queue as having failed, and the processing of that packet by the current shader stage is accordingly done (step 802).

On the other hand, when the shading response indicates that the requested shading has been performed (step 801—done), the corresponding item for the packet in question is then selected from the packet queue (step 803), the packet header for that item is then read in from memory (step 804), and once the packet header data has been read in step (step 805), the queue item is updated with the packet header data (step 806) (e.g. based on the result of the shading). The packet queue item is then marked as valid and the processing of that packet by the current shader stage is accordingly done (step 807).

As shown in FIG. 8, each packet queue item is thus processed in the same way. Completed packets are thus queued in the packet queue for output to the next shader stage in the geometry packet pipeline 82.

The next shader stage in the geometry packet pipeline 82 thus receives the shaded packets from the packet queue of the preceding shader stage and the shaded packets are then treated as the incoming packets to that next shader stage (and are thus processed as shown in FIG. 7).

As shown in FIG. 7, a given shader stage can thus receive incoming packets from a preceding shade stage in the pipeline, allocate corresponding output packets based on the incoming packet, process the incoming/output packets as desired (including handling any amplification and issuing shading requests, etc.). Any metadata resulting from the processing of the incoming/output packets can then be written to the respective packet header in the allocated memory pool portion for the packet and the packet is then propagated to the next stage in the geometry packet pipeline 82.

It will be appreciated that a subsequent shader stage when processing a given (child) packet may also need to use the output data that was generated by the processing of a corresponding (parent) packet in an earlier pipeline stage. Thus, data for packets may need to remain in its respective allocated memory pool portion until all subsequent shader stages that may need that data have finished processing of any corresponding child packets that may need that data. Packets can thus be de-allocated in the last stage of the geometry packet pipeline 82 that needs data for those packets. The packet de-allocation is in an embodiment performed by the shader stage backend.

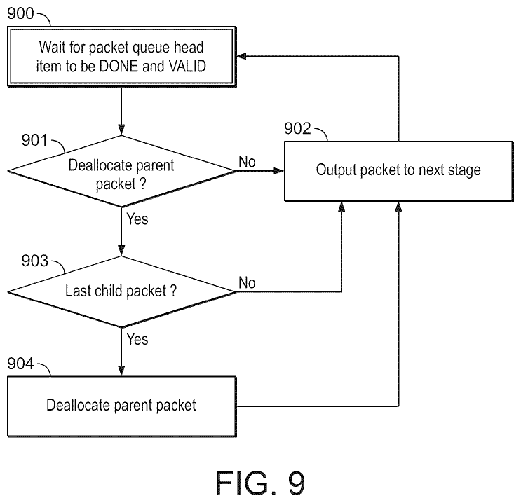

FIG. 9 is a flow chart showing the shader stage backend operation in more detail. As shown in FIG. 9, the shader stage backend waits for the packet at the head of the packet queue to be done and valid (i.e. step 807 in FIG. 8). Before pushing the packet to the next shader stage (step 902), the shader stage backend checks whether the current shader stage should deallocate a respective parent (or grandparent, etc.) packet of the packet that is currently being processed (step 901). This will be determined based on whether the current shader stage is the last shader stage that potentially needs access to the data stored for that parent packet. If not (step 901—no), the packet is output to the next stage (step 902), and the next packet at the head of the packet queue is processed in the same way.

Whereas, if the current shader stage should trigger deallocation of the parent packet (step 901—yes), it is then checked whether the current packet is the last child (grandchild, etc.) of the parent packet that is to be deallocated. If not (step 903—no), the packet is output to the next stage (step 902), and the next packet at the head of the packet queue (which in this case should be another child (grandchild, etc.) of the same parent packet) is processed in the same way. Once the last child (grandchild, etc.) of the parent packet that is to be allocated has been processed (step 903—yes), the shader stage backend can thus trigger invalidation of the parent packet so that its respective memory pool allocation can be deallocated (step 904).

This is done in the present embodiments by the shader stage backend messaging the memory manager 70 to trigger deallocation of the respective memory pool portion that was previously allocated for that parent packet.

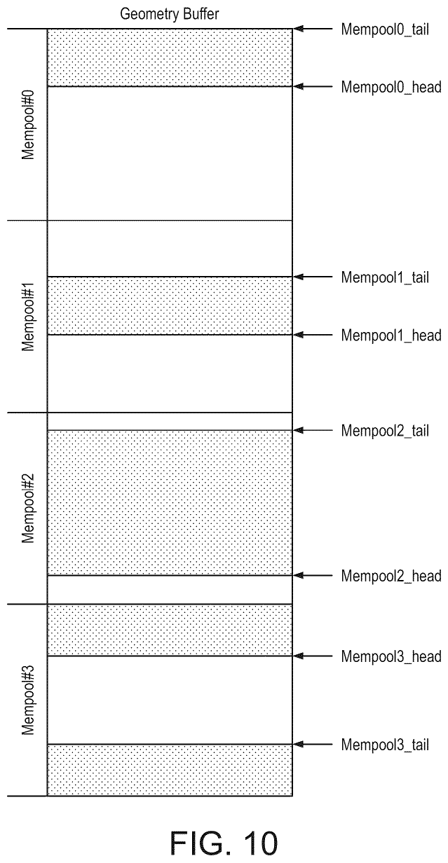

The memory allocation and deallocation will be described in more detail with respect to FIG. 10. For example, as shown in FIG. 3 (and FIG. 4), the geometry packet pipeline 42 also has a shared memory manager 70 which manages the memory allocations and deallocations for temporary packet data for each of the pipeline stages (e.g. as described above).

In this respect, as shown in FIG. 10, each shader stage circuit 44, 45, 46 is assigned its own memory pool for storing its respective data. In the present embodiments, as shown in FIG. 10, the memory pools reside in a defined overall geometry buffer for the geometry packet pipeline 42 that is portioned into multiple contiguous memory pools for use by the respective pipeline stages. Various arrangements would of course be possible in this regard and the geometry buffer may reside in any suitable and desired memory.

FIG. 10 thus shows schematically the layout of the geometry buffer in the present embodiments. As shown in FIG. 10, the geometry buffer contains several memory pools (implementation defined). For example, in FIG. 10, four memory pools are defined (Mempool #0, Mempool #1, Mempool #2, Mempool #3) for the six shader stages shown in FIG. 5 but other arrangements would of course be possible. In general, the memory pools can have different size but in the example shown in FIG. 10 each memory pool has the same size. As shown in FIG. 10, each memory pool has a respective pair of head and tail pointers, where the head pointer points to the address for the next allocation and tail pointer points to the address for the next deallocation.

Since allocations and deallocations in the memory pool always happen in order, this then avoids any need to track individual allocations. When allocations reach the end of a memory pool, the pointer moves to the beginning of the memory pool. As described above, allocated portions of the memory pool should thus be de-allocated to free memory in the memory pool for future packet allocations (and this memory de-allocation is done as described above in relation to FIG. 9).

For each memory pool, a respective memory pool access bit mask is generated during the initial pipeline configuration to indicate which pipeline stages access the memory pool. For example, the first shader stage accessing a given memory pool always allocates packets to that memory pool (and so the respective bit for that shader stage should be set accordingly in the memory pool access bit mask for that memory pool to indicate that it is the first shader stage accessing that memory pool). The last shader stage accessing a given memory pool (and for which a bit is set in the memory pool access bit mask for that memory pool) is then operable to trigger de-allocation of packets for that memory pool. Any intermediate shader stages can only access the memory pool, e.g. by reading and/or writing an already allocated packet (but cannot perform any memory allocations/de-allocations).

Thus, for any shader stage to access a given memory pool, the memory pool configuration should set a corresponding bit in the memory pool access mask, and memory pool access mask defines the access permissions to the memory pool in question.

In this respect, in the present embodiments, any shader stage, except the packet primitive drain unit can make requests to the memory manager to allocate packets, but a stage can only allocate packets in the memory pool designated for this stage for the current instance of executing the graphics processing pipeline 42 (note that the access permissions may be re-configured between instances of executing the graphics processing pipeline 42. Similarly, all stages, except the input packetizer 43 can request from the memory manager to deallocate one or multiple parent packets.

This means there a given stage can only allocate in the memory pool assigned to that stage (i.e. a memory pool cannot be shared by multiple stages for allocations). Because all packet payloads allocated by a given stage will be allocated in the same memory pool, this means that all packets should therefore share the same size (at least for the current instance of graphics processing pipeline 42 execution).

Thus, as described above, and as shown in FIG. 7, in the geometry packet pipeline 42, packets get allocated by the memory manager 70, when a shader stage in the geometry packet pipeline 42 requests it. Once allocated a respective portion of the designated memory pool, the packet can be issued for shading. Each stage in the geometry packet pipeline 42 contains an internal packet queue which buffers and tracks allocated packets payloads. The packet queue is operated in a ‘first-in-first-out’ manner so that packets are kept strictly in the order the associated packet payloads were allocated.

As shown in FIG. 8, when the shade done message for a shaded packet comes back to the shader stage which issued the request, the corresponding packet item in the packet queue for that packet is marked as complete. The shader will typically write some packet metadata to memory (i.e. a result of the packet shading) and this may need to be sent back and communicated to the shader stage. The shader stage is thus operable to issue a suitable memory read to the packet payload and copy the contents of the packet header to the respective portion of the designated memory pool allocated for that packet.

As shown in FIG. 9, a completed packet at the front of the packet queue then gets pushed to the next stage in the geometry packet pipeline 42. The content of the packet is typically used in the frontend processing by the next shader stage to determine if/how it must expand the parent packet into multiple child packets and allocate new packet payloads based on parameters from the parent packet.

Packets accordingly flow down the geometry packet pipeline 82 in order from one pipeline stage to the next enabled pipeline stage, and so on, with each stage in the geometry packet pipeline 82 processing packets in the order the packets were allocated.

The geometry packet pipeline 82 may thus enforce certain waits to ensure that strict packet ordering requirements are enforced as packets pass down the geometry packet pipeline 82. For example, a given shader stage should stall when waiting for a shade done response for any packets being shaded. Similarly, a given shader stage should stall when the shader stage requests a memory allocation for a packet, but the memory allocation is stalled by the memory manager 70 (this may typically happen when there are outstanding allocation requests to the same memory pool or if the memory pool is full). Finally, the geometry packet pipeline 82 may stall waiting for fully processed packets to be drained from the last shader stage.

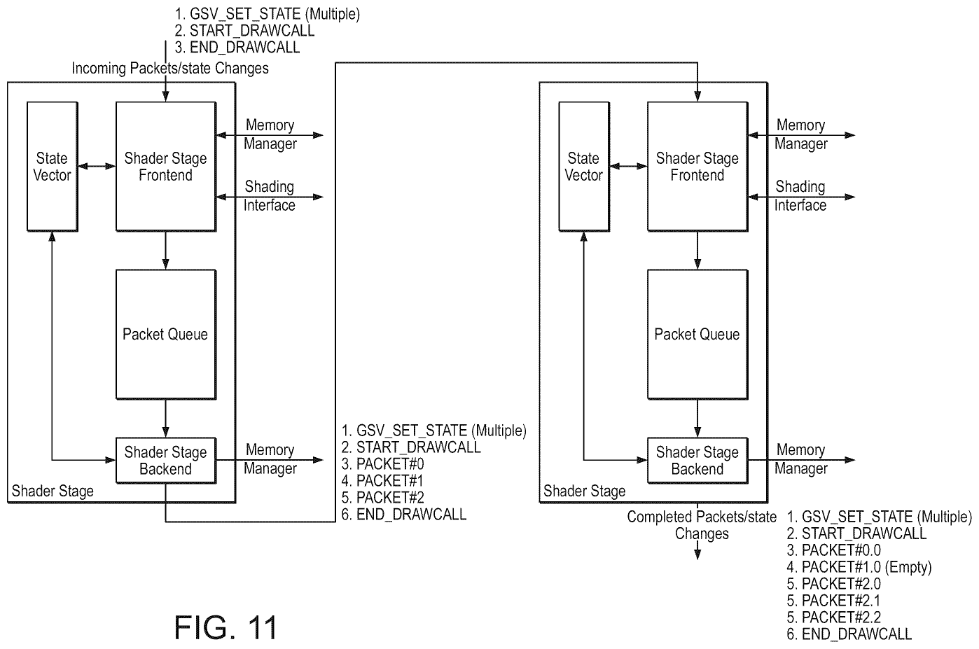

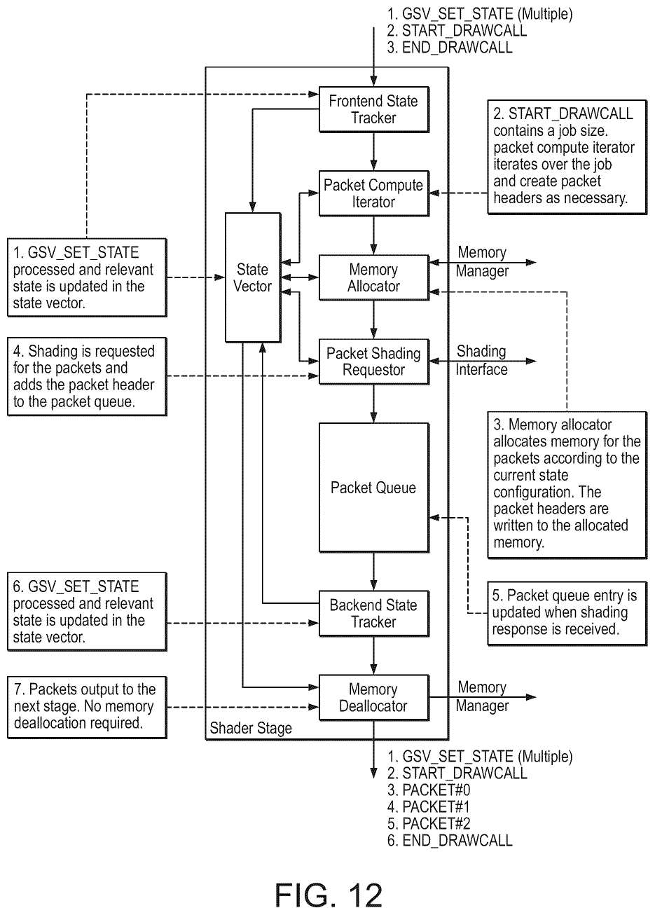

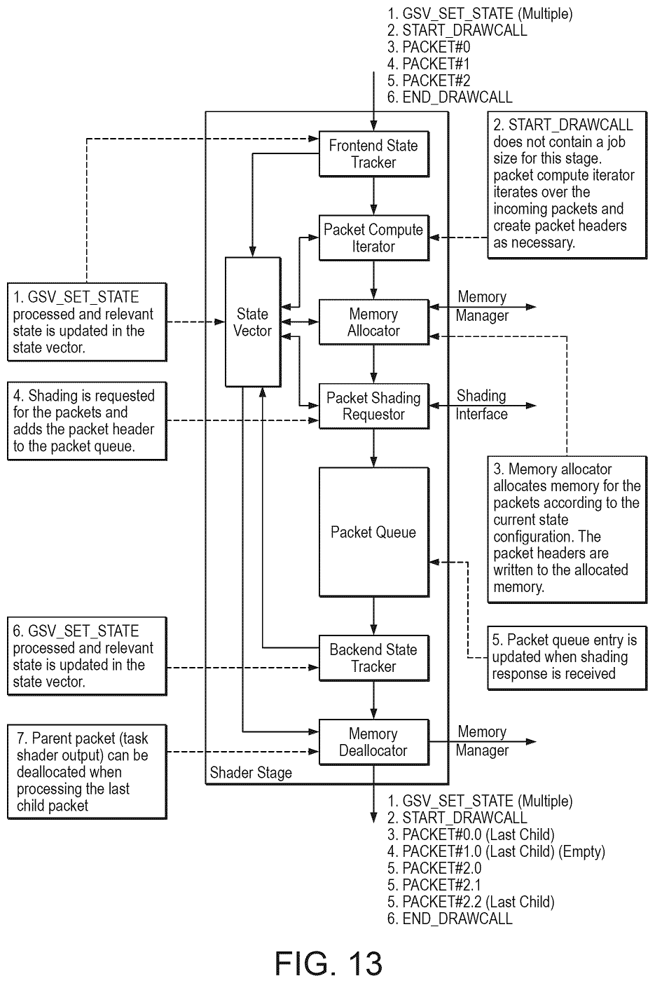

A specific example of the operation of a geometry packet pipeline according to an embodiment will now be described with reference to FIG. 11. In particular, in this example, task and mesh shaders are enabled, with FIG. 12 showing the operation of the task shader stage and FIG. 13 showing the operation of the following mesh shader stage.

FIG. 11 thus shows schematically an example of the processing within the geometry packet pipeline 42 for a draw call with task and mesh shaders enabled.

FIG. 11 thus shows the commands and packets at the interfaces of the task and mesh shaders stages. As shown in FIG. 11, and as described above, commands are passed down through the frontend, packet queue and backend of each shader stage, and output to the next shader stage. For example, as described above, incoming packets are processed in the frontend, and new packets might be created as part of these frontend processing operations. These packets are then inserted between the respective pair of START_DRAWCALL and END_DRAWCALL commands defining the current draw call

FIG. 12 shows in more detail the flow through the shader stage handling the task shader.

Thus, as shown in FIG. 12, the incoming commands starts with one or more commands to set state for the current draw call (a set of ‘GSV_SET_STATE’ commands). These GSV_SET_STATE commands are processed appropriately as will be described further below and used to update any relevant state in the state vector stored for that shader stage.

The START_DRAWCALL command defines a job size and the job is iterated over by a packet compute iterator of the shader stage frontend to create corresponding output packets (headers) as necessary. In this example, there are three invocations of the task shader. The first task shader outputs mesh invocation count=(1,1,1). The second outputs mesh invocation count=(0,0,0). The last outputs mesh invocation count=(1,1,2).

For each output packet created for the job, a memory allocator of the shader stage frontend then allocates a respective portion of the designated memory pool for the shader stage in question, and writes the packet (headers) to the allocated memory. Shading is then requested for the packets and the packets are added to the packet queue which is then updated as described above when shading responses are received.

The packets are then output to the mesh shader stage. FIG. 13 shows in more detail the flow through the shader stage handling the mesh shader. The mesh shading is then performed as shown in FIG. 13 (and as described above).

In this example, the main difference between task and mesh shading is that a job size is defined for the shader stage handling the task shader. This means that the task shader does not receive any incoming packets, but instead generates packets according to the defined job size. Whereas, the shader stage handling the mesh shader does not have a job size defined for the draw call but will instead receive a job size from the incoming packets.

Each incoming packet can define a different job size. This can be specified, for example, in the packet metadata (headers), which can indicate the number of child packets to invoke, etc.

Thus, in this example, the inputs to shader stage #0 (the task shader) are:
One or many commands to set the graphics state vector
A start of draw call command
An end of draw call command

Correspondingly, the inputs to shader stage #1 (the mesh shader) are:
The same commands as input to shader stage #0 for setting the graphics state vector
The same start of draw call command
The three packets output from the three invocations of the task shader
The end of draw call command

The outputs from shader stage #1 (the mesh shader) are thus:
The same commands as input to shader stage #0 for setting the graphics state vector
The same start of draw call command
The five output packets created in shader stage #1 (the mesh shader).
The end of draw call command

The outputs from shader stage #1 (the mesh shader) will then be provided in turn to the next enabled pipeline stage (see, e.g., FIG. 5), where the commands will be propagated through the pipeline stages, with additional packets being created/processed in each pipeline stage, as necessary, as part of the geometry packet pipeline 42 execution.

The geometry packet pipeline 42 is thus a new block of hardware within the graphics processor 2 that serves as a single entry point for the whole geometry flow, feeding the tiler or distributed binning cores, as appropriate.

As will be appreciated from the above, the geometry packet pipeline 42 enables programmable packet shading and configures a number of generic shader stage circuits. Thus, the geometry packet pipeline 42 may be implemented using one or more generic (in hardware) programmable shader stage circuits, with these shader stage circuits being configured in software to implement the desired logical stages of the geometry packet pipeline 42.

A further feature of the technology described herein is thus the initial configuration (and subsequent re-configuration) of the geometry packet pipeline 42.

For example, the geometry packet pipeline 42 in the present embodiments is configured in software at render pass granularity before pushing any work (i.e. draw calls) into the geometry packet pipeline 42. The initial configuration is thus performed to map the logical stages in the geometry flow (e.g. vertex shading, geometry shading, task and mesh shading, tessellation, transform feedback, or any valid geometry flow combination) to one or multiple stages in the geometry packet pipeline 42.

The initial pipeline configuration in the present embodiments may thus involve any, and in embodiments all, of: (i) enabling one or multiple stages of the geometry packet pipeline; (ii) configurating a shader program descriptor for each enabled stage; (iii) configuring workgroup dimensions for each stage; (iv) configuring one or more memory pools and binding each memory pool to a unique stage responsible for allocating packets in the memory pool; (v) configuring a packet size and layout for each memory pool; and (vi) setting a memory pool access mask for each memory pool indicates which shader stages can access the memory pool (with the first stage accessing a given memory pool always being the stage to allocate portions of that memory pool and the last stage accessing the memory pool always being the state to de-allocate portions of that memory pool).

Once the geometry packet pipeline 42 is configured, processing work can then be issued to the geometry packet pipeline 42.

In the present embodiments, this is done by the graphics processor executing a respective ‘RUN_PIPELINE’ instruction to trigger one or more instances of executing the geometry packet pipeline 42.

For example, a RUN_PIPELINE instruction may trigger execution of the geometry packet pipeline 42 for a set of one or more draw calls for which the same geometry packet pipeline 42 is to be executed. Thus, execution of a RUN_PIPELINE instruction may trigger a suitable sequence of per-draw call commands to be issued to the geometry packet pipeline 42 for each draw call that is associated with that RUN_PIPELINE instruction.

Accordingly, prior to issuing a RUN_PIPELINE instruction to trigger execution of the geometry packet pipeline 42 for a particular draw call, a set of GSV_SET_STATE commands (as mentioned above) may be issued to the geometry packet pipeline 42 in order to update some or all of the pipeline configuration information for the geometry packet pipeline 42 for the particular draw call in question.

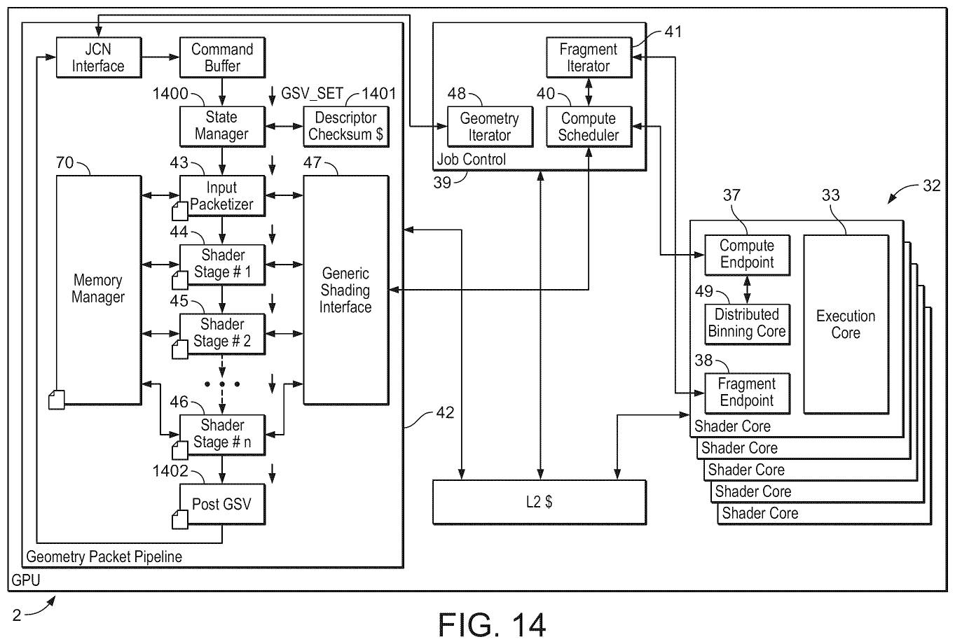

FIG. 14 shows in more detail how pipeline configuration information can be incrementally updated within the geometry packet pipeline 42 using the GSV_SET_STATE commands. For instance, the pipeline configuration information that is used to control operation of the geometry processing pipeline 42 is in an embodiment provided in the form of a graphics ‘state vector’ (GSV). A full copy of the GSV is stored at the end of the geometry packet pipeline 42, in particular in the post-GSV stage 1402 depicted in FIG. 14. This copy of the full GSV is updated each time a GSV_SET_STATE command is passed through the geometry packet pipeline 42.

However, as shown in FIG. 14, and as mentioned above, each shader stage 43, 44, 45 also maintains a local copy of a portion of the graphics pipeline configuration information that is relevant to that shader stage 43, 44, 45.

As will be explained further below, any GSV_SET_STATE commands passing through the geometry packet pipeline 42 are thus operable to update not only the full copy of the GSV stored in post-GSV stage 1402 but also the respective portions of the GSV stored locally to each of the shader stages, so that the respective portions of the GSV stored locally to each of the shader stages are kept up-to-date, even if the full copy of the GSV stored in post-GSV stage 1402 has not yet been updated.

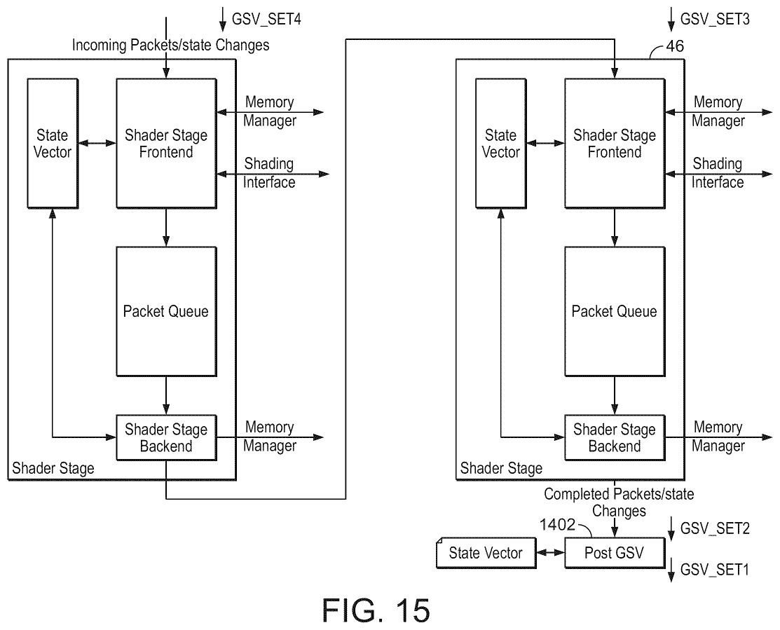

An example of this is shown in FIG. 15. FIG. 15 thus shows a ‘snapshot’ of the geometry packet pipeline 42 at a particular instant in time. In this example, there is shown a first and second shader stage. At this instant, a first GSV_SET_STATE command (GSV_SET1) has passed all the way through the geometry packet pipeline 42 and the full copy of the GSV stored in post-GSV stage 1402 is thus updated accordingly to reflect that update.

A second GSV_SET_STATE command (GSV_SET2) has passed through both shader stages but has not yet passed through the post-GSV stage 1402. Thus, the local copies of the GSV stored in association with both the first and second shader stages will reflect the state updates caused by the second GSV_SET_STATE command (GSV_SET2) (but the full copy of the GSV stored in post-GSV stage 1402 does not yet reflect these changes).

A third GSV_SET_STATE command (GSV_SET3) has passed through the first shader stage but has not yet passed through the second shader stage. Thus, the local copies of the GSV stored in association with the first shader stage (and any earlier stages (not shown)) will reflect the state updates caused by the third GSV_SET_STATE command (GSV_SET3) (but these changes will not yet be reflected in the copies of the GSV stored either in the post-GSV stage 1402 or for the second shader stage).

Finally, there is a fourth GSV_SET_STATE command (GSV_SET4) that has not yet passed through either of the first or second shader stages, and so this update is not yet reflected in the copies of the GSV stored for any of the shader stages or the post-GSV stage 1402.

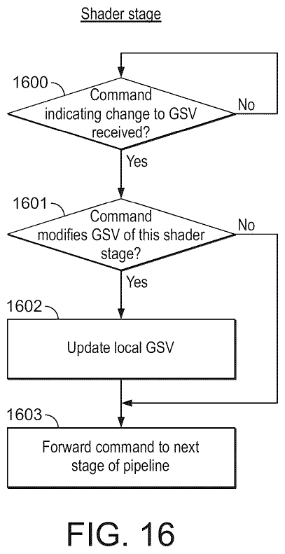

FIG. 16 is a flow chart showing the processing of a GSV_SET_STATE command within a particular shader stage.

Thus, as shown in FIG. 16, in response to the shader stage receiving a GSV_SET_STATE command (step 1600—yes), it is then checked whether or not the GSV_SET_STATE command updates the respective portion of the GSV associated with (and stored locally within) the shader stage in question. If not (step 1601—no), the GSV_SET_STATE command can simply be passed on for output to the next shader stage of the geometry packet pipeline 42 (step 1603).

On the other hand, if the GSV_SET_STATE command does update the respective portion of the GSV associated with (and stored locally within) the shader stage in question (step 1601—yes), the local copy of the portion of the GSV stored for the shader stage is updated (step 1602), and the GSV_SET_STATE command is then passed on for output to the next shader stage of the geometry packet pipeline 42 (step 1603).

It will be appreciated that these operations may be performed either in the “frontend” or “backend” processing of the particular shader stage, as appropriate.

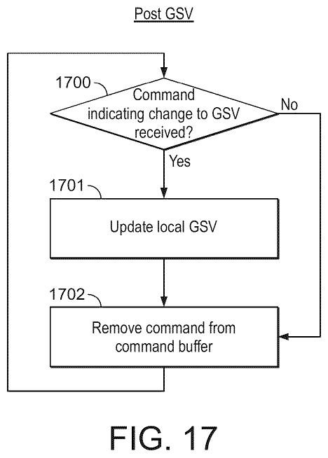

FIG. 17 is a flow chart showing the processing of a GSV_SET_STATE command within the post-GSV stage 1402.

In response to the post-GSV stage 1402 receiving a GSV_SET_STATE command (step 1700—yes), the post-GSV stage 1402 should (and does) always updates its copy of the ‘full’ GSV (step 1701).

In the present embodiments, the post-GSV stage 1402 is also responsible for triggering removal of any commands (including both GSV_SET_STATE commands and other commands) from the command buffer (step 1702).

This can then facilitate a more efficient suspend/resume mechanism. For example, on suspend, it is only necessary to save out the state of the command buffer and the copy of the GSV stored in the post-GSV stage 1402. On resume, a GSV_SET_STATE command can then be issued to repopulate the copy of the GSV stored in the post-GSV stage 1402, followed by any commands that were saved out from the command buffer, and once those commands have all been issued, the geometry processing pipeline 42 will then be returned to its state at the point at which processing was suspended.

As shown in FIG. 14, the geometry packet pipeline 42 in the present embodiments is also associated with a state manager 1400. The state manager 1400 is operable and configured to create descriptors of pipeline configuration information. That is, in the present embodiments, the geometry packet pipeline 42 is operable to create and update its own descriptors and write these descriptors to memory, as and when needed, so that the descriptors can subsequently be passed to other processing units in the graphics processor 2.

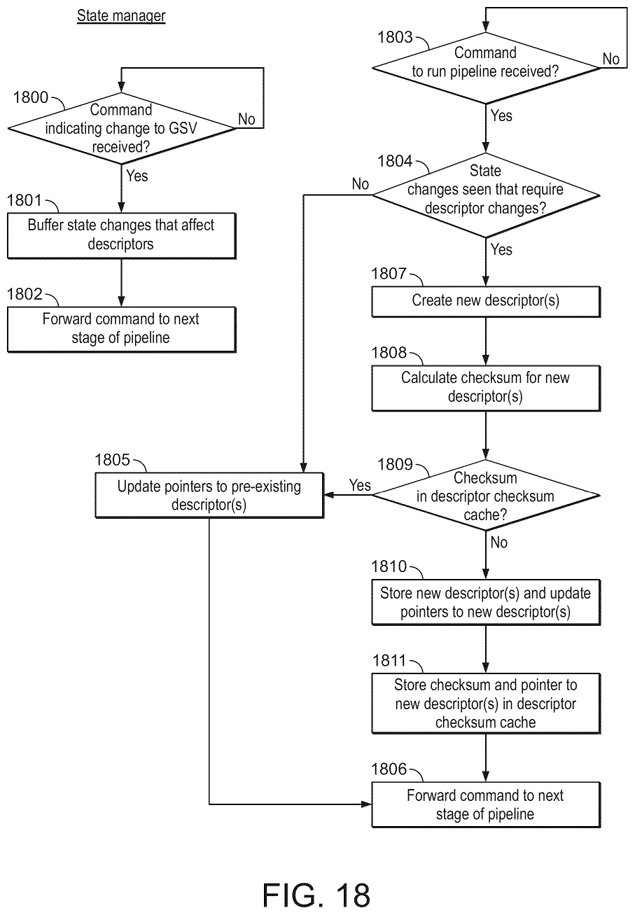

FIG. 18 is a flow chart showing the operation of the state manager 1400 in this regard.

Thus, in response to the state manager 1400 receiving a GSV_SET_STATE command (step 1800—yes), the state manager 1400 checks whether the state changes affects a descriptor, and if so, buffers that state change accordingly (step 1801). The GSV_SET_STATE command is then forwarded on to the next (i.e. first) stage of the geometry packet pipeline 42.

In this way, the state manager 1400 is operable to buffer and accumulate any and all state changes affecting descriptors for a particular draw call.

At some point, a new RUN_PIPELINE command will be received to trigger execution of the geometry packet pipeline 42 for another draw call (step 1803).

The state manager 1400 can then check whether it has buffered any state changes that affect descriptors. If not (step 1804—no), pointers to pre-existing descriptors can be updated, as required, (step 1805), and the RUN_PIPELINE command forwarded on to the next (i.e. first) stage of the geometry packet pipeline 42 (step 1806).

On the other hand, if the state manager 1400 has buffered state changes that affect descriptors (step 1804—yes), the state manager 1400 then proceeds to create new descriptors reflecting those state changes (step 1807) (it will be appreciated that the state manager 1400 need not, and generally will not, create new descriptors in full at this point, but may instead create only some of the descriptor, which information can then be used to create the full descriptor that is to be written to memory, as required. Thus, there may be further processing (e.g. padding) involved in creating a full descriptor but for simplicity this further processing is not shown in FIG. 18).

Rather than simply creating the new descriptor at this point and then writing out the newly created descriptor to memory, a checksum is then calculated over some or all of the newly created descriptor(s) (step 1808), and the checksum for the newly created descriptor(s) is compared to corresponding checksums for pre-existing descriptor(s) that are stored in a descriptor checksum cache. Thus, as shown in FIG. 14, the state manager 1400 is associated with a descriptor checksum cache 1401 for this purpose.

If the checksum for the newly created descriptor(s) matches a checksum for a pre-existing descriptor that is stored in a descriptor checksum cache (step 1809—yes), this means that the descriptor that would be created is already stored in memory, and so the newly created descriptor(s) can be discarded at this point (thus saving having to write it out), and a pointer instead updated to point to the relevant pre-existing descriptor (step 1805), before the command is forwarded on to the next (i.e. first) stage of the geometry packet pipeline 42 (step 1806).

Whereas, if the checksum for the newly created descriptor(s) does not match a checksum for a pre-existing descriptor that is stored in a descriptor checksum cache (step 1809—no), the newly created descriptor(s) should be stored in memory and the pointer updated to point to the memory location in which the newly created descriptor(s) are store (step 1810). The checksum for the newly created descriptor(s) is then stored into the descriptor checksum cache (step 1811), and the command is then forwarded on the next (i.e. first) stage of the geometry packet pipeline 42 (step 1806), as above.

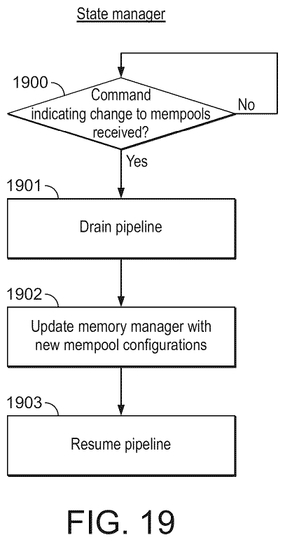

In some cases, a state update may relate to the configuration of the set of memory pools that are associated with the pipeline stages. In that case, it may be necessary to drain the geometry packet pipeline 42 between draw calls. This is also handled by the state manager 1400, e.g. as shown in FIG. 19.

Thus, as shown in FIG. 19, if the state manager 1400 receives a command indicating a change to the memory pool configuration (step 1900—yes), the state manager 1400 stalls issuing of any further commands into the geometry packet pipeline 42 to allow the geometry packet pipeline 42 to drain (step 1901) prior to updating the memory manager with the new memory pool configurations (step 1902). Once the memory manager has been updated with the new memory pool configurations, the geometry packet pipeline 42 can then resume processing further commands (step 1903).

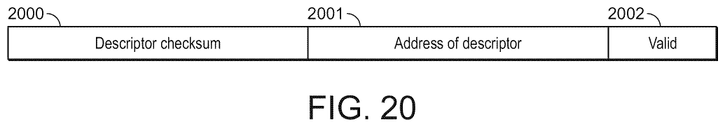

FIG. 20 shows schematically an example of a descriptor checksum cache entry. As described above, in relation to FIG. 18, the use of the descriptor checksum cache entry avoids the need to store newly created descriptor(s) where it can be determined that the newly created descriptor(s) is equal to a descriptor that is already stored. Each descriptor checksum cache entry thus comprises a suitable descriptor checksum 2000 that is calculated based on certain parts of the pipeline configuration information contained in the descriptor.

This may therefore limit what information is allowed to change between descriptors. For example, scissoring parameters may be expected to change between draw calls, and so this is in an embodiment included in the checksum. However, the framebuffer size should not change between draw calls and so is in an embodiment not included in the checksum. This however means that if the framebuffer size does change between draw calls, the descriptor checksum cache may need to be cleared to avoid checksum collisions.

The descriptor checksum cache entry also contains an address for the memory location 2001 in which the descriptor is stored and a valid flag 2002 that can be used to indicate whether or not that descriptor checksum cache entry is valid.

Various arrangements would be possible in this regard.

The technology described herein, at least in embodiments, thus provides an improved graphics processor operation, in particular through the use of a configurable graphics processing pipeline that can be used to support various different graphics processing flows using a set of ‘generic’ shader stage circuits.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor, the graphics processor comprising:
one or more processing circuits configured to execute a plurality of pipeline stages for a processing pipeline, wherein the operation of the one or more processing circuits to execute the processing pipeline is controlled based on a set of pipeline configuration information,
wherein a copy of the full set of pipeline configuration information including respective portions of pipeline configuration information relating to individual pipeline stages defining the processing pipeline is stored in association with the processing pipeline as a whole, and
wherein an individual pipeline stage of the plurality of pipeline stages is operable and configured to separately maintain a local copy of a respective portion of the pipeline configuration information relating to that pipeline stage,
the method comprising:
to update some or all of the set of pipeline configuration information:
issuing a corresponding state update command to update the set of pipeline configuration information into the processing pipeline; and
once the state update command has passed through the processing pipeline, updating the copy of the full set of pipeline configuration information that is stored in association with the processing pipeline as a whole;
the method further comprising:
when the state update command is to update a respective portion of pipeline configuration information relating to a particular pipeline stage, the particular pipeline stage when processing the state update command updating its respective local copy of that respective portion of the pipeline configuration information accordingly.

2. The method of claim 1, wherein when one or more state update commands are received to update pipeline configuration information for which a corresponding descriptor is stored in memory for use by a subsequent instance of processing pipeline execution, this is tracked, and prior to performing the subsequent instance of processing pipeline execution, information indicative of a new descriptor for the updated pipeline configuration information is created to allow the new descriptor to be written to memory.

3. The method of claim 2, wherein prior to writing out a new descriptor for any updated pipeline configuration information to memory, it is determined whether the new descriptor would correspond to a descriptor that is already stored in memory, and when it is determined that the new descriptor would correspond to a descriptor that is already stored in memory, the information indicative of the new descriptor is discarded and the descriptor that is already stored in memory is used for the subsequent instance of processing pipeline execution.

4. The method of claim 3, wherein the determining whether the new descriptor would correspond to a descriptor that is already stored in memory comprises checking a respective value calculated based on some or all of the information indicative of the new descriptor with corresponding values calculated for one or more descriptors that are already stored in memory.

5. The method of claim 1, wherein in response to a command to suspend a current instance of processing pipeline execution, the method comprising suspending the current instance of processing pipeline execution by:
stopping issuing any new commands to the processing pipeline;
saving a copy of the full set of pipeline configuration information that is stored in association with the processing pipeline as a whole; and
saving information indicative of any commands that are currently being processed within the processing pipeline.

6. The method of claim 5, wherein in response to a command to resume an instance of processing pipeline execution that has been previously been suspended, the method comprises resuming the instance of processing pipeline execution by:
issuing into the processing pipeline one or more state update command(s) including the copy of the full set of pipeline configuration information that was saved at the point at which the instance of processing pipeline execution was suspended; and then
issuing any commands that were being processed within the processing pipeline at the point at which the instance of processing pipeline execution was suspended into the processing pipeline in the same order they were originally issued.

7. The method of claim 1, wherein the plurality of pipeline stages are executed by a corresponding set of plural generic pipeline stages, wherein each generic pipeline stage of the set of generic pipeline stages can be configured as a respective, different shader stage to be executed as part of a processing pipeline.

8. A graphics processor comprising:
one or more processing circuits that configured to execute a plurality of pipeline stages for a processing pipeline, wherein the operation of the one or more processing circuits to execute the processing pipeline is controlled based on a set of pipeline configuration information; and
a post pipeline stage that is operable and configured to maintain a copy of a full set of pipeline configuration information including respective portions of pipeline configuration information relating to individual pipeline stages defining the processing pipeline, such that a copy of the full set of pipeline configuration information is stored for the processing pipeline as a whole,
wherein an individual pipeline stage of the plurality of pipeline stages is operable and configured to separately maintain a local copy of a respective portion of the pipeline configuration information relating to that pipeline stage,
and wherein the graphics processor operable and configured to:
in response to a state update command to update some or all of the set of pipeline configuration information being issued into the processing pipeline:
once the state update command has passed through the processing pipeline, update the copy of the full set of pipeline configuration information that is stored in the post pipeline stage for the processing pipeline as a whole; and
when the state update command is to update a respective portion of pipeline configuration information relating to a particular pipeline stage, process the state update command by that particular pipeline stage to update the local copy of that respective portion of the pipeline configuration information that is maintained by that particular pipeline stage.

9. The graphics processor of claim 8, wherein when one or more state update commands are received to update pipeline configuration information for which a corresponding descriptor is to be stored in memory for use by a subsequent instance of processing pipeline execution, prior to performing the subsequent instance of processing pipeline execution, is created to allow the new descriptor to be written to memory.

10. The graphics processor of claim 9, wherein prior to writing out any new descriptors for any updated pipeline configuration information to memory, it is determined whether the new descriptor would correspond to a descriptor that is already stored in memory, and when it is determined that the new descriptor would correspond to a descriptor that is already stored in memory, the information indicative of the new descriptor is discarded and the descriptor that is already stored in memory is used for the subsequent instance of processing pipeline execution.

11. The graphics processor of claim 10, wherein the determining whether the new descriptor corresponds to a descriptor that is already stored in memory comprises checking a respective value calculated based on some or all of the information indicative of the new descriptor with corresponding values calculated for one or more descriptors that are already stored in memory.

12. The graphics processor of claim 8, wherein in response to a command to suspend a current instance of processing pipeline execution, the graphics processor is configured to suspend the current instance of processing pipeline execution by:
stopping issuing any new commands to the processing pipeline;
saving a copy of the full set of pipeline configuration information that is stored in association with the processing pipeline as a whole; and
saving information indicative of any commands that are currently being processed within the processing pipeline.

13. The graphics processor of claim 12, wherein in response to a command to resume an instance of processing pipeline execution that has been previously been suspended, the graphics processor is configured to resume the instance of processing pipeline execution by:
issuing into the processing pipeline one or more state update command(s) including the copy of the full set of pipeline configuration information that was saved at the point at which the instance of processing pipeline execution was suspended; and then
issuing any commands that were being processed within the processing pipeline at the point at which the instance of processing pipeline execution was suspended into the processing pipeline in the same order they were originally issued.

14. The graphics processor of claim 8, wherein the plurality pipeline stages are executed by a corresponding set of plural generic pipeline stages, wherein each generic pipeline stage of the set of generic pipeline stages can be configured as a respective, different shader stage to be executed as part of a processing pipeline.

15. A non-transitory computer readable storage medium storing computer software code which when executing on one or more processors performs a method of operating a graphics processor, the graphics processor comprising:
one or more processing circuits configured to execute a plurality of pipeline stages for a processing pipeline, wherein the operation of the one or more processing circuits to execute the processing pipeline is controlled based on a set of pipeline configuration information,
wherein a copy of the full set of pipeline configuration information including respective portions of pipeline configuration information relating to individual pipeline stages defining the processing pipeline is stored in association with the processing pipeline as a whole, and
wherein an individual pipeline stage of the plurality of pipeline stages is operable and configured to separately maintain a local copy of a respective portion of the pipeline configuration information relating to that pipeline stage,
the method comprising:
to update some or all of the set of pipeline configuration information:
issuing a corresponding state update command to update the set of pipeline configuration information into the processing pipeline; and
once the state update command has passed through the processing pipeline, updating the copy of the full set of pipeline configuration information that is stored in association with the processing pipeline as a whole;
the method further comprising:
when the state update command is to update a respective portion of pipeline configuration information relating to a particular pipeline stage, the particular pipeline stage when processing the state update command updating its respective local copy of that respective portion of the pipeline configuration information accordingly.

16. The non-transitory computer readable storage medium of claim 15, wherein when one or more state update commands are received to update pipeline configuration information for which a corresponding descriptor is stored in memory for use by a subsequent instance of processing pipeline execution, this is tracked, and prior to performing the subsequent instance of processing pipeline execution, information indicative of a new descriptor for the updated pipeline configuration information is created to allow the new descriptor to be written to memory.

17. The non-transitory computer readable storage medium of claim 16, wherein prior to writing out a new descriptor for any updated pipeline configuration information to memory, it is determined whether the new descriptor would correspond to a descriptor that is already stored in memory, and when it is determined that the new descriptor would correspond to a descriptor that is already stored in memory, the information indicative of the new descriptor is discarded and the descriptor that is already stored in memory is used for the subsequent instance of processing pipeline execution.

18. The non-transitory computer readable storage medium of claim 17, wherein the determining whether the new descriptor would correspond to a descriptor that is already stored in memory comprises checking a respective value calculated based on some or all of the information indicative of the new descriptor with corresponding values calculated for one or more descriptors that are already stored in memory.

19. The non-transitory computer readable storage medium of claim 15, wherein in response to a command to suspend a current instance of processing pipeline execution, the method comprising suspending the current instance of processing pipeline execution by:
stopping issuing any new commands to the processing pipeline;
saving a copy of the full set of pipeline configuration information that is stored in association with the processing pipeline as a whole; and
saving information indicative of any commands that are currently being processed within the processing pipeline.

20. The non-transitory computer readable storage medium of claim 19, wherein in response to a command to resume an instance of processing pipeline execution that has been previously been suspended, the method comprises resuming the instance of processing pipeline execution by:
issuing into the processing pipeline one or more state update command(s) including the copy of the full set of pipeline configuration information that was saved at the point at which the instance of processing pipeline execution was suspended; and then
issuing any commands that were being processed within the processing pipeline at the point at which the instance of processing pipeline execution was suspended into the processing pipeline in the same order they were originally issued.
